(19) United States
(12) Patent Application Publication
(10) Pub. No.: US 2026/0260880 A1
(43) Pub. Date: Sep. 3, 2026

(54) SUPERFAST RECHARGING ZINC-BASED ENERGY STORAGE DEVICES

(71) Applicant: NanoTech Energy, Inc., Sunny Isles Beach, FL (US)

(72) Inventors: Maher F. EL-KADY, Los Angeles, CA (US); Mir F. MOUSAVI, Los Angeles, CA (US); Haosen WANG, Los Angeles, CA (US)

(21) Appl. No.: 18/845,813

(22) PCT Filed: Mar. 10, 2023
(86) PCT No.: PCT/US2023/064124

§ 371 Date: Sep. 10, 2024

Related U.S. Application Data
(60) Provisional application No. 63/319,229, filed on Mar. 11, 2022.

(51) Int. Cl. H01M 4/42; B82Y 40/00; H01M 4/02; H01M 4/04; H01M 4/24; H01M 4/26; H01M 4/52; H01M 4/58; H01M 4/66; H01M 10/26

(52) U.S. Cl. CPC H01M 4/42; B82Y 40/00; H01M 4/049; H01M 4/244; H01M 4/26; H01M 4/52; H01M 4/5815; H01M 4/663; H01M 10/26; H01M 2004/027; H01M 2004/028; H01M 2300/0014

(57) ABSTRACT

Provided herein are rechargeable aqueous Zn∥Ni energy storage devices that exhibit improved electrochemical performance high performance and super-long life. The combination of a high-performance Zn-based anode and an efficient Ni-based cathode herein, which aqueous battery chemistry with outstanding, form an energy storage device with high energy and power densities and cycling stability.

### CROSS-REFERENCE TO RELATED APPLICATION

This application claims the benefit of U.S. Provisional Application No. 63/319,229 filed on Mar. 11, 2022, which is hereby incorporated by reference in its entirety.

### BACKGROUND

The rapid evolution of portable electronic devices, the internet-of-things, and electric vehicles has greatly boosted the global demand for high-performance, low cost, and environmentally friendly energy storage devices. Although lithium-ion batteries are used for many application, their high demand has increased the cost of their raw materials, and are becoming prohibitively expensive.

Aqueous rechargeable batteries that water-based electrolytes are cheaper, easier, and safer to manufacture compared with non-aqueous rechargeable batteries. Further, aqueous batteries exhibit high ionic conductivities (~1 S/cm) compared to non-aqueous batteries (1-10 mS/cm)

### SUMMARY

Aqueous zinc-nickel batteries are low cost, safe, environmentally friendly, non-flammable, and have the potential to serve as an alternative to lithium-ion batteries. However, current zinc-based electrodes suffer from low coulombic efficiency and dendritic growth over extended use, and the capacity of commercial nickel-based electrodes and cells made therefrom fade rapidly.

Many commercial aqueous zinc-based energy storage devices store energy via a chemical conversion mechanism. Such devices, however, exhibit low coulombic efficiency and poor cycling stability (e.g., 10-200 cycles) due to side reactions (e.g., the irreversible formation of ZnO and Zn(OH)₂ byproducts on electrodes), and the dissolution of the active mass into the electrolyte. Further, capacity of these devices fades at low current regimes beyond a certain depth-of-discharge (DOD). While water-in-salt electrolytes have been employed to curb such deterioration, such electrolytes must be super-concentrated and are thus often prohibitively expensive.

Other commercial aqueous zinc-based energy storage devices store energy via insertion/de-insertion of Zn²⁺ in a reaction similarly employed in lithium-ion batteries. Such zinc-based energy storage devices employ Prussian blue analogues metal oxides (e.g., manganese oxides, and vanadium oxides) and metal phosphates (e.g., vanadium phosphates, and iron phosphates) with layered structures, organic compounds, and polyanionic compounds as cathode materials. Unfortunately these devices often exhibit poor rate capabilities due to the sluggish transport kinetics of the hydrated divalent Zn²⁺ cations.

Further, the zinc in current zinc-based energy storage devices forms sharp dendrites during use, which can break the separator between electrodes and create a short circuit. Additionally, while formation of a solid electrolyte interface (SEI) protects the electrodes in lithium-ion batteries against undesirable chemical reactions, H₂ evolution interferes with the deposition and dissolution of Zn ions in zinc-based energy storage devices. Although the advancements in electrolyte formulation and electrode architecture, and the use of organic additives pulsed charging protocols have been attempted to reduce dendrite formation, such approaches typically blunt the cost, scalability, and safety advantages of commercial aqueous zinc-based energy storage devices. Finally, zinc-based energy storage devices that employ nickel-based cathodes exhibit charge irreversibility issues, poor long-term stability, and high-rate capability, especially at high charge-discharge depths and high specific current values.

As such, there exists a need to improve the current zinc-based energy storage devices that employ insertion/de-insertion of Zn²⁺ and/or chemical conversion reactions. Therefore, provided herein are rechargeable aqueous Zn∥Ni energy storage devices that exhibit improved electrochemical performance high performance and super-long life. One aspect provided herein is an energy storage device comprising: an anode comprising a bimetallic particle on a graphene scaffold; a cathode comprising a layered double hydroxide (LDH) particles; and an electrolyte. In some embodiments, the Zn∥Ni energy storage devices herein comprise a negative electrode (anode) comprising a Zn_{X}Mn_{1-X}CO₃@G (ZMG) nanocomposite (where G is a graphene scaffold), a positive electrode (cathode) comprising a sulfidated Ni—Co—Fe (nickel, cobalt, iron) layered double hydroxide (LDHS), and a ZnO saturated 6.0 M KOH electrolyte.

Aspects disclosed herein provide an energy storage device comprising: an anode comprising a bimetallic particle on a graphene scaffold, the bimetallic particle comprising ZnₓM₁₋ₓCO₃ nanoparticles, wherein M is iron, cobalt, aluminum, manganese, or any combination thereof, and wherein x is less than 1; a cathode comprising a layered double hydroxide (LDH) nanotube; and an electrolyte. In some embodiments, layered double hydroxide (LDH) nanotube comprises one or more layered double hydroxide nanoparticles. In some embodiments, the bimetallic particle comprises Zn_{X}M₁₋ₓCO₃ nanoparticles, wherein M is manganese, and wherein x is less than 1. In some embodiments, a molar ratio of Zn to M is about 1:1 to about 7:1. In some embodiments, the graphene scaffold comprises graphene aerogel, graphene hydrogel, or both. In some embodiments, the LDH nanotubes comprise sulfidated Ni—Co—Fe nanotubes. In some embodiments, the LDH nanotubes have a diameter of about 50 to about 150 nm. In some embodiments, the LDH nanotubes have a diameter of about 100 nm. In some embodiments, the LDH particles comprise sulfidated Ni—Co—Fe particles. In some embodiments, the LDH nanotubes or LDH particles comprise aluminum, barium, bismuth, cadmium, calcium, chromium, cobalt, coppern, indium, iron, lead, manganese, mercury, nickel, strontium, tin, zinc, or any combination thereof. In some embodiments, the electrolyte comprises a hydroxide and a stabilizer. In some embodiments, the hydroxide comprises aluminum hydroxide, barium hydroxide, benzyltrimethylammonium hydroxide, beryllium hydroxide, cadmium hydroxide, cesium hydroxide, calcium hydroxide, cerium(III) hydroxide, chromium acetate hydroxide, chromium(III) hydroxide, cobalt(II) hydroxide, cobalt(III) hydroxide, copper(I) hydroxide, copper(II) hydroxide, curium hydroxide, gallium(III) hydroxide, germanium(II) hydroxide, gold(III) hydroxide, indium(III) hydroxide, iron(II) hydroxide, iron(III) oxide-hydroxide, lanthanum hydroxide, lead(II) hydroxide, lead(IV) hydroxide, lithium hydroxide, magnesium hydroxide, manganese(II) hydroxide, mercury(II) hydroxide, metal hydroxide, nickel(II) hydroxide, potassium hydroxide, rubidium hydroxide, sodium hydroxide, strontium hydroxide, tetrabutylammonium hydroxide, tetramethylammonium hydroxide, thallium hydroxide, thallium(I) hydroxide, thallium(III) hydroxide, tin(II) hydroxide, uranyl hydroxide, zinc hydroxide, zirconium(IV) hydroxide, or any combination thereof. In some embodiments, the stabilizer comprises zinc oxide, zinc hydroxide, sodium zincate, potassium zincate, bismuth oxide, cadmium oxide, indium sulfate, lead oxide, a metallic zinc powder, or any combination thereof. In some embodiments, the hydrogen evolution inhibitor comprises bismuth oxide, cadmium oxide, a conductive ceramic, lead oxide, a metallic zinc powder antimony sulfate, gallium hydroxide, indium sulfate, lithium hydroxide, or any combination thereof. In some embodiments, the electrolyte has a concentration by mass, by volume, or both of the hydroxide of about 22% to about 91%. In some embodiments, the electrolyte has a concentration by volume of the hydroxide of about 220 g/L to about 900 g/L. In some embodiments, the electrolyte has a concentration by mass, by volume, or both of the stabilizer of about 1% to about 5%. In some embodiments, the electrolyte further comprises a conductivity enhancer comprising a conductive ceramic. In some embodiments, the conductive ceramic comprises lead zirconate titanate (PZT), barium titanate (BT), strontium titanate (ST), calcium titanate (CT), magnesium titanate (MT), calcium magnesium titanate (CMT), zinc titanate (ZT), lanthanum titanate (LT), and neodymium titanate (NT), barium zirconate (BZ), calcium zirconate (CZ), lead magnesium niobate (PMN), lead zinc niobate (PZN), lithium niobate (LN), barium stannate (BS), calcium stannate (CS), magnesium aluminum silicate, magnesium silicate, barium tantalate, titanium dioxide, niobium oxide, zirconia, quartz, silica, sapphire, beryllium oxide, zirconium tin titanate, indium tin oxide (ITO), lanthanum-doped strontium titanate (SLT), yttrium-doped strontium titanate (SYT), yttria-stabilized zirconia (YSZ), gadolinium-doped ceria (GDC), lanthanum strontium gallate magnesite (LSGM), or any combination thereof. In some embodiments, the electrolyte further comprises: an additive comprising calcium hydroxide, calcium titanate, calcium zincate, potassium fluoride, sodium phosphate tribasic, potassium phosphate, sodium fluoride, potassium borate, potassium carbonate, or any combination thereof; a hydrogen evolution inhibitor comprising bismuth oxide, cadmium oxide, a conductive ceramic, lead oxide, a metallic zinc powder antimony sulfate, gallium hydroxide, indium sulfate, lithium hydroxide, or any combination thereof, or both. In some embodiments, a mass ratio between the electroactive materials in the anode and the cathode is about 1:1 to about 7:1 In some embodiments, the electrolyte has a concentration of the KOH of about 1 M to about 20 M. In some embodiments, a separator is between the anode and the cathode. In some embodiments, the device has a rate capability of at least about 300 mAh/g at 12 A/g. In some embodiments, the device has a rate capability of at least about 100 mAh/g at 300 A/g. In some embodiments, the device has a specific energy of at least about 550 Wh/kg. In some embodiments, the device has a specific power of at least about 400 kW/kg. In some embodiments, the device has a capacity retention of at least about 95% after about 16,000 cycles at 100% depth of discharge. In some embodiments, the device has a time constant of less than about 0.5 seconds. In some embodiments, the device is configured for use in an electric vehicle, an energy grid, a home battery, or any combination thereof.

Another aspect provided herein is a method of forming an electrode, the method comprising: (a) forming a first solution comprising graphene oxide and a solvent; (b) adding zinc nitrate hexahydrate and manganese nitrate tetrahydrate to the first solution; (c) adding a reducing agent to the first solution to form a second solution; (d) heating the second solution; (e) cooling the second solution; washing the second solution; and (f) freeze drying the second solution.

In some embodiments, step (a) comprises ultrasonicating the graphene oxide in the solvent. In some embodiments, a concentration of the graphene oxide in the first solution is about 0.5 g/L to about 10 g/L. In some embodiments, the ultrasonification is performed for about 1 minute to about 120 minutes. In some embodiments, the ultrasonification is performed at room temperature. In some embodiments, the zinc nitrate hexahydrate has a concentration of about 1 mM to about 1,000 mM. In some embodiments, the manganese nitrate tetrahydrate has a concentration of about 0.3 mM to about 300 mM. In some embodiments, step (c) occurs for a period of time of at least about 0.1 hour to about 10 hours. In some embodiments, a molar ratio of Zn2+ to Mn2+ is about 1:1 to about 7:1. In some embodiments, the reducing/doping agent comprises urea, hydrazine hydrate, sodium borohydride, ascorbic acid, hydroquinone, sodium cholate, sodium citrate, hydroiodic acid, bovine serum albumin, dopamine, glucose, fructose, sucrose, melatonin, starch, oxalic acid, tannic acid, gallic acid, caffeic acid, or any combination thereof. In some embodiments, step (d) is performed at a temperature of about 90° C. to about 200° C. In some embodiments, step (d) is performed for a period of time of about 1 hour to about 24 hours. In some embodiments, the method further comprises stirring the first solution before step (c), after step (c), or both. In some embodiments, stirring the first solution is performed for a period of time of about 1 minute to about 100 minutes. In some embodiments, the method further comprises adding a conductive additive, a binder, and a solvent to the second solution to form a slurry; coating a current collector with the slurry; and drying the slurry on the current collector. In some embodiments, the conductive additive comprises carbon black, graphene, carbon nanotubes, graphite, carbon nanofibers, or any combination thereof. In some embodiments, the binder comprises polytetrafluoroethylene, styrene butadiene rubber, carboxymethyl cellulose, polyvinylidene fluoride, or any combination thereof. In some embodiments, the solvent comprises ethanol, polyvinylidene fluoride, or any combination thereof. In some embodiments, the slurry is dried on the current collector a temperature of about 30° C. to about 100° C. In some embodiments, the slurry is dried on the current collector for a period of time of about 1 hour to about 24 hours.

Another aspect provided herein is a method of forming an electrode, the method comprising: (a) synthesizing Ni—Co—Fe layer double hydroxide nanoplatelets; (b) heating the Ni—Co—Fe layer double hydroxide nanoplatelets; and (c) drying the Ni—Co—Fe layer double hydroxide nanoplatelets.

In some embodiments, step (a) comprises: immersing a metal foam in an acid; washing the metal foam; electrodepositing the metal foam in a electrosynthesis solution; and washing the Ni—Co—Fe layer double hydroxide nanoplatelets on the metal foam. In some embodiments, the electrodeposition is performed by a three-electrode (3E) cell comprising: the metal foam as a working electrode; a reference electrode; and a counter electrode. In some embodiments, the reference electrode comprises Ag/AgCl, Hg/HgO, saturated calomel, or any combination thereof.

In some embodiments, the counter electrode comprises platinum, gold, carbon, graphite, or any combination thereof. In some embodiments, the acid comprises HCl, HNO3, or both. In some embodiments, the washing is performed for a period of time of about 1 minute to about 10 minutes. In some embodiments, the electrodeposition is performed by applying two or more consecutive potential cycles. In some embodiments, the electrodeposition is performed by applying about 10 to about 15 consecutive potential cycles. In some embodiments, the electrodeposition is performed for a period of time of less than about 5 minutes. In some embodiments, the electrodeposition is performed from about −0.7 V to about −1.2 V In some embodiments, the electrodeposition is performed at a scan rate of about 1 mV/s to about 1,000 mV/s. In some embodiments, the electrosynthesis solution comprises Co(NO3)2·6H2O, Ni(NO3)2·6H2O, Fe(NO3)3·9H2O, and KNO3. In some embodiments, the method further comprises drying the Ni—Co—Fe layer double hydroxide nanoplatelets on the metal foam. In some embodiments, drying the Ni—Co—Fe layer double hydroxide nanoplatelets on the metal foam is performed at a temperature of about 30° C. to about 100° C. In some embodiments, drying the Ni—Co—Fe layer double hydroxide nanoplatelets on the metal foam is performed for a period of time of about 1 hour to about 24 hours. In some embodiments, the Ni—Co—Fe layer double hydroxide nanoplatelets is heated at a temperature of about 90° C. to about 200° C. In some embodiments, the Ni—Co—Fe layer double hydroxide nanoplatelets is heated for a time period of about 1 hour to about 24 hours. In some embodiments, the Ni—Co—Fe layer double hydroxide nanoplatelets are dried at room temperature. In some embodiments, the method further comprises washing the Ni—Co—Fe layer double hydroxide nanoplatelets before heating the Ni—Co—Fe layer double hydroxide nanoplatelets. In some embodiments, the method is performed in less than about 5 minutes. In some embodiments, the metal foam comprises a nickel foam. In some embodiments, the method further comprises sulfidating the Ni—Co—Fe layer double hydroxide nanoplatelets. In some embodiments, sulfidating the Ni—Co—Fe layer double hydroxide nanoplatelets comprises heating the Ni—Co—Fe layer double hydroxide nanoplatelets in the presence of a sulfidizing agent. In some embodiments, the sulfidizing agent comprises Na2S. In some embodiments, the heating is performed at a temperature of about 100° C. to about 180° C. In some embodiments, the heating is performed for a period of time of about 4 hours to about 12 hours.

Another aspect provided herein is a method of applying regenerative voltage pulse to an energy storage device, the method comprising: after a sequence of galvanostatic charge-discharge (GCD) cycles: applying a first voltage pulse at a first voltage for a first period of time; and applying a second voltage pulse at a second voltage for a second period of time.

In some embodiments, the first voltage is about 1.5 V to about 2.5 V. (2.05)v the second voltage is about 1 V to about 1.5 V. (1.3) In some embodiments, the first period of time, the second period of time, or both is about 15 seconds to about 30 seconds. In some embodiments, the sequence of GCD cycles comprises about 8 GCD cycles to about 14 GCD cycles.

Aspects disclosed herein provide a method of applying regenerative voltage pulse to a zinc-based energy storage device to maintain or increase the initial capacity, the method comprising: after a sequence of at least 10 galvanostatic charge-discharge (GCD) cycles: (a) applying a first voltage pulse at a first voltage for a first period of time; (b) applying a second voltage pulse at a second voltage for a second period of time; (c) repeating (a) and (b) at least every 10 galvanostatic charge-discharge (GCD) cycles; and (d) maintaining 100% of the initial device capacity after about 100 galvanostatic charge-discharge (GCD) cycles. In some embodiments, the first voltage is greater than the second voltage. In some embodiments, the first voltage is about 1.5 V to about 2.5 V. In some embodiments, the first voltage is 2.05 V. The In some embodiments, the second voltage is about 1 V to about 1.5 V. In some embodiments, the second voltage is 1.3 V. In some embodiments, the first period of time, the second period of time, or both is about 15 seconds to about 30 seconds. In some embodiments, the sequence of GCD cycles comprises about 8 GCD cycles to about 14 GCD cycles. In some embodiments, (a) and (b) result in structural reorganization of an active materials during cycling of the energy storage device. In some embodiments, result in the expansion of pores within an active material during cycling of the energy storage device. In some embodiments, (a) and (b) result in the expansion of pores within an active materials during cycling of the energy storage device and increased penetration of electrolyte ions the pores. In some embodiments, (a) and (b) result in kinetic activation of the electrode. In some embodiments, the zinc-based energy storage device comprises: an anode comprising bimetallic ZnₓM₁₋ₓCO₃ nanoparticles on a graphene scaffold, wherein M is iron, cobalt, aluminum, manganese, or any combination thereof, and wherein x is less than 1; a cathode comprising sulfidated Ni—Co—Fe layered double hydroxide nanotubes; an electrolyte; or combinations thereof.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 shows a schematic illustration of an exemplary energy storage device, according to one or more embodiments herein;

FIG. 2 shows a schematic illustration of the electrochemical interactions in an exemplary energy storage device, according to one or more embodiments herein;

FIG. 3 shows a schematic illustration of the unit cell structure of an exemplary Zn_{2/3}Mn_{1/3}CO₃@G (ZMG), nanocomposite according to one or more embodiments herein;

FIG. 4A shows an image of an exemplary ZMG nanocomposite at a scale of 100 um, according to one or more embodiments herein;

FIG. 4B shows an image of an exemplary ZMG nanocomposite at a scale of 10 um, according to one or more embodiments herein;

FIG. 4C shows an image of an exemplary ZMG nanocomposite at a scale of 2 um, according to one or more embodiments herein;

FIG. 4D shows an image of an exemplary ZMG nanocomposite at a scale of 200 nm, according to one or more embodiments herein;

FIG. 5A shows elemental mapping images of an exemplary pristine ZMG nanocomposite, according to one or more embodiments herein;

FIG. 5B shows elemental mapping images of an exemplary cycled ZMG nanocomposite, according to one or more embodiments herein;

FIG. 6A shows a graph of a full survey X-ray photoelectron (XPS) spectrum of an exemplary ZMG nanocomposite, according to one or more embodiments herein;

FIG. 6B shows a graph of a high resolution core-level of Zn2p of an exemplary ZMG nanocomposite, according to one or more embodiments herein;

FIG. 6C shows a graph of a high resolution core-level of Mn2p of an exemplary ZMG nanocomposite, according to one or more embodiments herein;

FIG. 6D shows an XRD spectrum of graphene oxide, reduced graphene oxide, and an exemplary ZMG nanocomposite, according to one or more embodiments herein;

FIG. 7A shows a CV graph of an exemplary an exemplary ZMG nanocomposite with Zn:Mn molar ratios ranging from 1:1 to 7:1, according to one or more embodiments herein;

FIG. 7B shows an LSV graph of an exemplary an exemplary ZMG nanocomposite with Zn:Mn molar ratios ranging from 1:1 to 7:1, according to one or more embodiments herein;

FIG. 8A shows a deconvoluted core level XPS spectra of C1s of the exemplary ZMG nanocomposite, according to one or more embodiments herein;

FIG. 8B shows a deconvoluted core level XPS spectra of O1s of the exemplary ZMG nanocomposite, according to one or more embodiments herein;

FIG. 8C shows a deconvoluted core level XPS spectra of N1s of the exemplary ZMG nanocomposite, according to one or more embodiments herein;

FIG. 9A shows Raman spectra of graphene oxide, reduced graphene oxide, and an exemplary ZMG nanocomposite, according to one or more embodiments herein;

FIG. 9B shows an energy-dispersive X-ray (EDX) spectrum of an exemplary ZMG nanocomposite, according to one or more embodiments herein;

FIG. 10A shows a scanning electron microscope (SEM) image of an exemplary first ZMG nanocomposite before 16,000 charging and discharging cycles at 10 mA/cm², according to one or more embodiments herein;

FIG. 10B shows a SEM image of an exemplary first ZMG nanocomposite after 16,000 charging and discharging cycles at 10 mA/cm², according to one or more embodiments herein;

FIG. 10C shows a SEM image of an exemplary second ZMG nanocomposite before 16,000 charging and discharging cycles at 10 mA/cm², according to one or more embodiments herein;

FIG. 10D shows a SEM image of an exemplary second ZMG nanocomposite after 16,000 charging and discharging cycles at 10 mA/cm², according to one or more embodiments herein;

FIG. 11A shows a SEM image of an exemplary third ZMG nanocomposite before applying regenerative pulses, according to one or more embodiments herein;

FIG. 11B shows a SEM image of an exemplary third ZMG nanocomposite after applying regenerative pulses, according to one or more embodiments herein;

FIG. 11C shows a SEM image of an exemplary fourth ZMG nanocomposite before applying regenerative pulses, according to one or more embodiments herein;

FIG. 11D shows a SEM image of an exemplary fourth ZMG nanocomposite after applying regenerative pulses, according to one or more embodiments herein;

FIG. 12A shows an elemental mapping image of zinc in an exemplary ZMG electrode before applying the regenerative pulses, according to one or more embodiments herein;

FIG. 12B shows an elemental mapping image of manganese in an exemplary ZMG electrode before applying the regenerative pulses, according to one or more embodiments herein;

FIG. 12C shows an elemental mapping image of oxygen in an exemplary ZMG electrode before applying the regenerative pulses, according to one or more embodiments herein;

FIG. 12D shows an elemental mapping image of nitrogen in an exemplary ZMG electrode before applying the regenerative pulses, according to one or more embodiments herein;

FIG. 12E shows an elemental mapping image of carbon in an exemplary ZMG electrode before applying the regenerative pulses, according to one or more embodiments herein;

FIG. 13A shows an elemental mapping image of zinc in an exemplary ZMG electrode after applying the regenerative pulses, according to one or more embodiments herein;

FIG. 13B shows an elemental mapping image of manganese in an exemplary ZMG electrode after applying the regenerative pulses, according to one or more embodiments herein;

FIG. 13C shows an elemental mapping image of oxygen in an exemplary ZMG electrode after applying the regenerative pulses, according to one or more embodiments herein;

FIG. 13D shows an elemental mapping image of nitrogen in an exemplary ZMG electrode after applying the regenerative pulses, according to one or more embodiments herein;

FIG. 13E shows an elemental mapping image of carbon in an exemplary ZMG electrode after applying the regenerative pulses, according to one or more embodiments herein;

FIG. 14A shows cyclic voltammetry (CV) curves of an exemplary ZMG electrode and a bare copper mesh, at a scan rate of 50 mV/s, according to one or more embodiments herein;

FIG. 14B shows CV curves of an exemplary ZMG electrode at scan rates from 5 mV/s to 200 mV/s, according to one or more embodiments herein;

FIG. 15A shows discharge curves of an exemplary ZMG electrode at charging rates from 25 mA/cm² to 105 mA/cm², according to one or more embodiments herein;

FIG. 15B shows a phase angle and time constant of an exemplary ZMG electrode, according to one or more embodiments herein;

FIG. 16A shows linear sweep voltammetry (LSV) curves of exemplary Zn@GA (graphene aerogel), Zn—Co@GA, Zn—Al@GA, Zn—Fe@GA and Zn—Mn@GA electrodes, according to one or more embodiments herein;

FIG. 16B shows CV curves of exemplary Zn@GA, Zn—Co@GA, Zn—Al@GA, Zn—Fe@GA and Zn—Mn@GA electrodes, according to one or more embodiments herein;

FIG. 17A shows LSV curves of an exemplary ZMG electrode at scan rates from 1 mV/s to 100 mV/s, according to one or more embodiments herein;

FIG. 17B shows a chronoamperometric response of an exemplary ZMG, according to one or more embodiments herein;

FIG. 18A shows CV curves of exemplary ZMG electrodes with metal to graphene aerogel weight percentage ratios from 1.4 to 13.7, according to one or more embodiments herein;

FIG. 18B shows a graph of the capacities of exemplary ZMG electrodes with metal to graphene aerogel weight percentage ratios from 1.4 to 13.7, according to one or more embodiments herein;

FIG. 19A shows the capacity of an exemplary ZMG electrode at charging rates from 25 mA/cm² to 105 mA/cm², according to one or more embodiments herein;

FIG. 19B shows a CV curve of an exemplary ZMG electrode at a sweep rate of 5 mV/s, according to one or more embodiments herein;

FIG. 20 shows a Nyquist plot of an exemplary ZMG electrode over a frequency range from 100 kHz to 10 mHz, according to one or more embodiments herein;

FIG. 21A shows a low magnification SEM image of exemplary nickel-cobalt-iron layered-double-hydroxide (LDH) nano-flakes grown on a nickel foam substrate by cyclic voltammetry, according to one or more embodiments herein;

FIG. 21B shows a high magnification SEM image of exemplary LDH nano-flakes grown on a nickel foam substrate by cyclic voltammetry, according to one or more embodiments herein;

FIG. 21C shows a low magnification SEM image of an exemplary sulfated LDH (LDHS) electrode hydrothermally synthesized on a nickel foam substrate, according to one or more embodiments herein;

FIG. 21D shows a high magnification SEM image of an exemplary LDHS electrode hydrothermally synthesized on a nickel foam substrate, according to one or more embodiments herein;

FIG. 22 shows an SEM image of an exemplary LDHS electrode, according to one or more embodiments herein;

FIG. 23A shows an elemental mapping image of nickel in an exemplary LDHS electrode, according to one or more embodiments herein;

FIG. 23B shows an elemental mapping image of cobalt in an exemplary LDHS electrode, according to one or more embodiments herein;

FIG. 23C shows an elemental mapping image of sulfur in an exemplary LDHS electrode, according to one or more embodiments herein;

FIG. 23D shows an elemental mapping image of oxygen in an exemplary LDHS electrode, according to one or more embodiments herein;

FIG. 23E shows an elemental mapping image of iron in an exemplary LDHS electrode, according to one or more embodiments herein;

FIG. 24A shows a low magnification SEM image of an exemplary pristine LDHS electrode, according to one or more embodiments herein;

FIG. 24B shows a high magnification SEM image of an exemplary pristine LDHS electrode, according to one or more embodiments herein;

FIG. 24C shows a low magnification SEM image of an exemplary LDHS electrode after 16,000 charge-discharge cycles at a current density of 10 mA/cm², according to one or more embodiments herein;

FIG. 24D shows a high magnification SEM image of an exemplary LDHS electrode after 16,000 charge-discharge cycles at a current density of 10 mA/cm², according to one or more embodiments herein

FIG. 25 shows an energy-dispersive x-ray spectroscopy (EDX) spectra of an exemplary LDHS electrode, according to one or more embodiments herein;

FIG. 26A shows an Ni 2p XPS spectra of an exemplary LDHS electrode, according to one or more embodiments herein;

FIG. 26B shows an Co 2p XPS spectra of an exemplary LDHS electrode, according to one or more embodiments herein;

FIG. 26C shows an O is XPS spectra of an exemplary LDHS electrode, according to one or more embodiments herein;

FIG. 26D shows an S 2p XPS spectra of an exemplary LDHS electrode, according to one or more embodiments herein;

FIG. 27A shows CV curves of exemplary LDH nano-flakes and an exemplary LDHS electrode, according to one or more embodiments herein;

FIG. 27B shows charge-discharge profiles of exemplary LDH nano-flakes and an exemplary LDHS electrode, according to one or more embodiments herein;

FIG. 27C shows charge-discharge profiles of an exemplary LDHS electrode, at specific current values of 1 A/g, 2 A/g, 5 A/g, and 10 A/g, according to one or more embodiments herein;

FIG. 27D shows charge-discharge profiles of an exemplary LDHS electrode, at specific current values of 20 A/g, 50 A/g, 100 A/g, and 200 A/g, according to one or more embodiments herein;

FIG. 28A shows an full survey XPS spectrum of an exemplary LDHS electrode, according to one or more embodiments herein;

FIG. 28B shows a high resolution core-level Fe 2P XPS spectrum of an exemplary LDHS electrode, according to one or more embodiments herein;

FIG. 28C shows a XRD spectrum of an exemplary LDH and an exemplary LDHS electrode, according to one or more embodiments herein;

FIG. 29A shows CV curves of exemplary LDH and exemplary LDHS electrode samples sulfidated in the presence of 5 mM, 7.5 mM, 10 mM, 12 mM, and 15 mM Na₂S, according to one or more embodiments herein;

FIG. 29B shows galvanic discharge-charge (GCD) curves of exemplary LDH and exemplary LDHS electrode samples sulfidated in the presence of 5 mM, 7.5 mM, 10 mM, 12 mM, and 15 mM Na2S, according to one or more embodiments herein;

FIG. 30A shows a graph of specific capacity versus specific current for an exemplary LDHS electrode, according to one or more embodiments herein;

FIG. 30B shows a CV curve of an exemplary LDHS electrode at a sweep rate of 5 mV/s, according to one or more embodiments herein;

FIG. 31A shows a first set of Nyquist plots of an exemplary LDHS electrode, according to one or more embodiments herein;

FIG. 31B shows a second set of Nyquist plots of an exemplary LDHS electrode, according to one or more embodiments herein;

FIG. 31C shows the phase angle and time constant of an exemplary LDHS electrode, according to one or more embodiments herein;

FIG. 32 shows CV curves of an exemplary zinc-nickel (Zn∥Ni) energy storage device, according to one or more embodiments herein;

FIG. 33A shows a Nyquist plot of an exemplary Zn∥Ni energy storage device, according to one or more embodiments herein;

FIG. 33B shows a Bode plot of an exemplary Zn∥Ni energy storage device, according to one or more embodiments herein;

FIG. 34A shows a graph of charge rate vs capacity of an exemplary Zn∥Ni energy storage device, according to one or more embodiments herein;

FIG. 34B shows a graph of voltage vs capacity of an exemplary Zn∥Ni energy storage device at charge rates from 1 mA/cm² to 100 mA/cm², according to one or more embodiments herein;

FIG. 35A shows a cycling stability graph of exemplary Zn∥Ni energy storage devices with different additives, according to one or more embodiments herein;

FIG. 35B shows a capacity retention graph of an exemplary Zn∥Ni energy storage device, according to one or more embodiments herein;

FIG. 36A shows CV curves of an exemplary ZMG electrode an exemplary LDHS electrode, according to one or more embodiments herein;

FIG. 36B shows CV curves of an exemplary Zn∥Ni energy storage device at voltage windows of 1.3V to 2.1V, according to one or more embodiments herein;

FIG. 36C shows a cycling stability graph of an exemplary Zn∥Ni energy storage devices that have and have not received a regenerative pulse, and at current densities of 1 mA/cm² and 10 mA/cm², according to one or more embodiments herein;

FIG. 36D shows a cycling stability graph of an exemplary Zn∥Ni energy storage device at capacity retention and coulombic efficiencies of 1 mA/cm² and 10 mA/cm², according to one or more embodiments herein;

FIG. 37A shows an operando XRD pattern of an exemplary ZMG electrode during the first charge cycle after a regenerative pulse is applied, according to one or more embodiments herein;

FIG. 37B shows an operando XRD patterns of an exemplary ZMG electrode before and after a regenerative pulse is applied, according to one or more embodiments herein;

FIG. 37C shows a Zn 2p XPS spectra of an exemplary Zn∥LDHS energy storage device and an exemplary ZMG∥LDHS energy storage device, according to one or more embodiments herein;

FIG. 37D shows a Mn 2p XPS spectra of an exemplary Zn∥LDHS energy storage device and an exemplary ZMG∥LDHS energy storage device before and after applying regenerative pulses, according to one or more embodiments herein;

FIG. 37E shows CV curves of an exemplary Zn∥LDHS energy storage device and an exemplary ZMG∥LDHS energy storage device, according to one or more embodiments herein;

FIG. 37F shows a GCD curves of an exemplary Zn∥LDHS energy storage device and an exemplary ZMG∥LDHS energy storage device, according to one or more embodiments herein;

FIG. 38 shows a rate capability graph of an exemplary Zn∥LDHS energy storage device and an exemplary ZMG∥LDHS energy storage device, according to one or more embodiments herein;

FIG. 39A shows a pulse-driven regeneration graph of an exemplary Zn∥Ni energy storage device, according to one or more embodiments herein;

FIG. 39B shows a cycling stability graph of an exemplary Zn∥Ni energy storage device, according to one or more embodiments herein; and

FIG. 40 shows a chart comparing the performance of current energy storage devices with the disclosed energy storage devices, according to one or more embodiments herein.

### DETAILED DESCRIPTION

Aqueous zinc-nickel batteries are low cost, safe, environmentally friendly, and non-flammable. However, current zinc-based electrodes suffer from low coulombic efficiency and dendritic growth, and the capacity of commercial nickel-based electrodes fades rapidly.

While rechargeable aqueous energy storage devices have employed monovalent cations (e.g. Na⁺, K⁺), divalent charge carriers, and multivalent charge carriers (e.g. Zn²⁺, Mg²⁺, Al³⁺) rechargeable zinc-based energy storage devices are made of eco-friendly and earth-abundant elements, and exhibit superb electrochemical performance. Further, zinc's high theoretical capacity (e.g. 820 mAh/g), and low redox potential (e.g. −0.8 V) enable the formation of zinc-based energy storage devices for use in such applications as large-scale energy storage.

Many commercial aqueous zinc-based energy storage devices store energy via a chemical conversion mechanism. Such devices, however, exhibit low coulombic efficiency and poor cycling stability (e.g., 10-200) due to side reactions (e.g. irreversible formation of ZnO and Zn(OH)₂ byproducts) and the dissolution of the active mass into the electrolyte. Further, capacity of these devices fades at low current regimes beyond a certain depth-of-discharge (DOD). While water-in-salt electrolytes have been employed to curb such deterioration, such electrolytes must be super-concentrated and are thus often prohibitively expensive.

Other commercial aqueous zinc-based energy storage devices store energy via insertion/de-insertion of Zn²⁺ in a reaction similarly employed in lithium-ion batteries. Such zinc-based energy storage devices employ Prussian blue analogues metal oxides (e.g. manganese oxides, and vanadium oxides) and metal phosphates (e.g. vanadium phosphates, and iron phosphates) with layered structures, organic compounds, and polyanionic compounds as cathode materials. Unfortunately these devices often exhibit poor rate capabilities due to the sluggish transport kinetics of the hydrated divalent Zn²⁺ cations.

Further, the zinc in current zinc-based energy storage devices forms sharp dendrites during use, which can break the separator between electrodes and create a short circuit. Additionally, while formation of a solid electrolyte interface (SEI) protects the electrodes in lithium-ion batteries against undesirable chemical reactions, H₂ evolution interferes with the deposition and dissolution of Zn ions in zinc-based energy storage devices. Although the advancements in electrolyte formulation and electrode architecture, and the use of organic additives pulsed charging protocols have been attempted to reduce dendrite formation, such approaches typically blunt the cost, scalability, and safety advantages of commercial aqueous zinc-based energy storage devices. Finally, zinc-based energy storage devices that employ nickel-based cathodes exhibit charge irreversibility issues, poor long-term stability, and high-rate capability, especially at high charge-discharge depths and high specific current values.

As such, there exists a need to improve the current zinc-based energy storage devices that employ insertion/de-insertion of Zn²⁺ and/or chemical conversion reactions. Therefore, provided herein are rechargeable aqueous Zn∥Ni energy storage devices that exhibit improved electrochemical performance high performance and super-long life. In some embodiments, the Zn∥Ni energy storage devices herein comprise a negative electrode (anode) comprising a Zn_{X}Mn_{1-X}CO₃@G (ZMG) nanocomposite (where G is a graphene scaffold), a positive electrode (cathode) comprising a sulfidated Ni—Co—Fe (nickel, cobalt, iron) layered double hydroxide (LDHS), and a ZnO saturated 6.0 M KOH electrolyte. In some embodiments, the graphene scaffold comprises graphene aerogel, graphene hydrogel, or both. In some embodiments, the graphene in the graphene hydrogel are stabilized by a liquid medium, wherein the graphene in the graphene aerogel are self-stabilized.

The combination of a high-performance Zn-based anode and an efficient Ni-based cathode herein, which aqueous battery chemistry with outstanding, form an energy storage device with high energy and power densities and cycling stability. Further the energy storage devices herein are low-cost, easy-to-fabricate, environmentally benign, and safe.

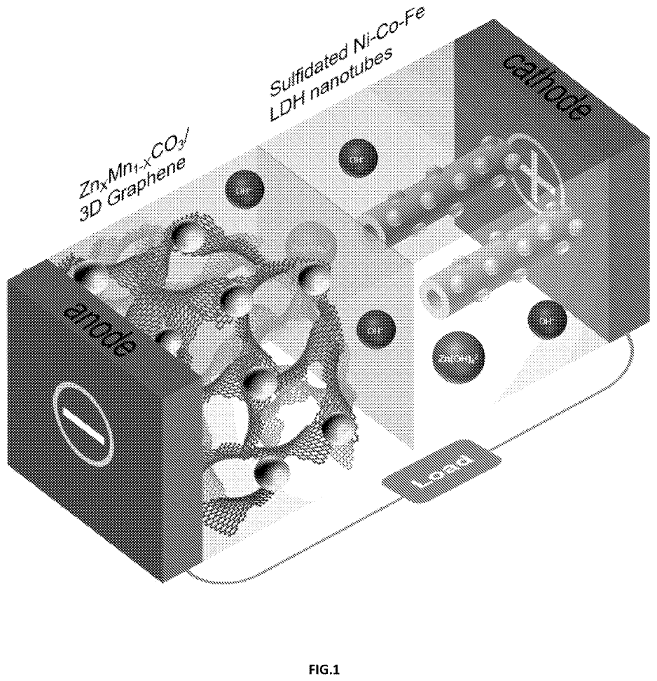

FIG. 1 shows a schematic illustration of an exemplary energy storage device. The energy devices herein exhibit improved conductivity, electroactivity capacity, rate capability (e.g. 356 mAh/g at 12 A/g; 108 mAh/g at 300 A/g), specific energy (e.g. 568 Wh/kg), specific power (e.g. 429 kW/kg), and capacity retention (e.g. ~100% after 16,000 cycles at 100% depth of discharge). The use of an electrochemical pulse-driven regenerative mechanism and the electrodes' structural features, synergistic elements, and pseudocapacitance enable the improved performance of the Zn-based energy storage devices over previously reported Zn-based energy storage devices.

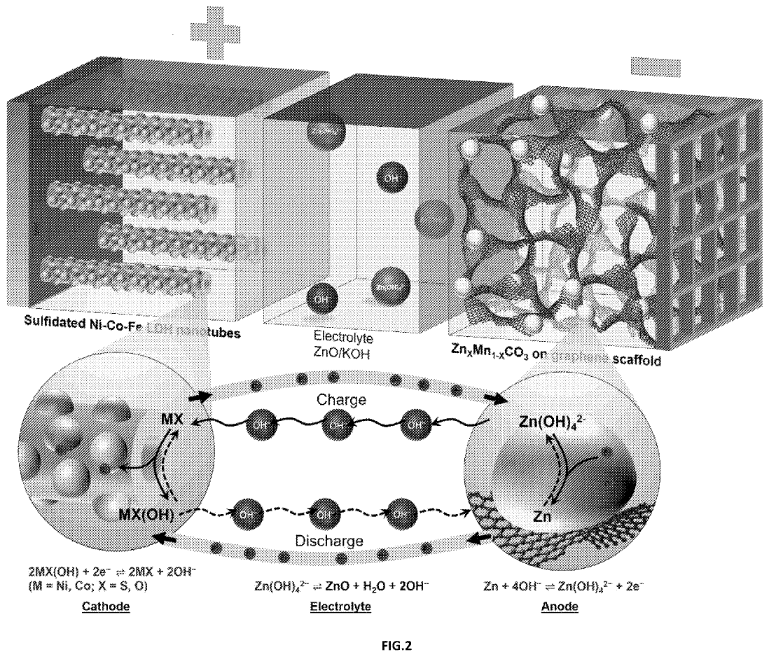

FIG. 2 shows a schematic illustration of the electrochemical interactions in an exemplary energy storage device. As shown, the exemplary energy storage devices comprises an anode comprising a bimetallic zinc-manganese carbonate nanoparticles loaded onto graphene hydrogel, a cathode comprising sulfidated Ni—Co—Fe layered double hydroxide nanoparticles, and a ZnO saturated KOH electrolyte.

### ZMG Composites

Provided herein are ZnₓM₁₋ₓCO₃ (ZMG) nanocomposite wherein M is iron, cobalt, aluminum, manganese, or any combination thereof and wherein x is less than 1. In some embodiments, the ZMG nanocomposite is an iron-based ZMG, a cobalt-based ZMG, an aluminum-based ZMG, a manganese-based ZMG, or any combination thereof.

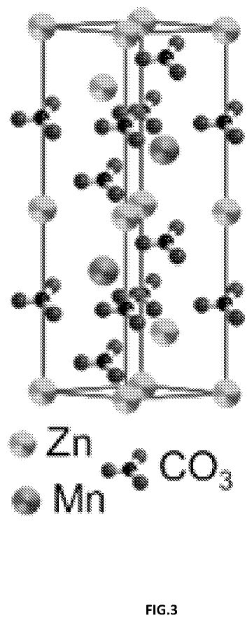

FIG. 3 shows a schematic illustration of the unit cell structure of an exemplary Zn_{2/3}Mn_{1/3}CO₃@G nanocomposite. In some embodiments, the atomic scale distribution of the zinc and manganese into a single crystal bimetallic carbonate has a synergistic effect that enables increased electron transfer properties.

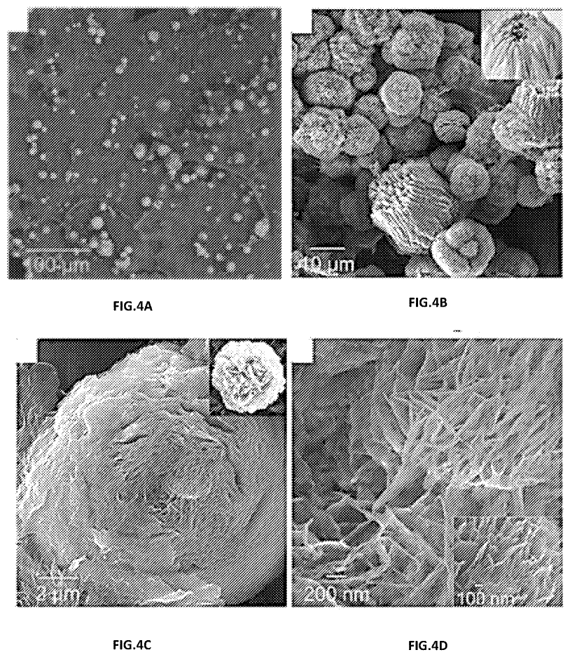

FIGS. 4A-4D show images of an exemplary ZMG nanocomposite at scales of 100 um, 10 um, 2 um, and 200 nm, respectively. As shown, the graphene sheets of the exemplary ZMG nanocomposite have smooth surfaces coated by bimetal carbonate microparticles. Further, the graphene scaffold forms a three-dimensional interconnected porous network that surrounds the bimetallic carbonate nanoparticles. Unlike commercial electrodes, the structure shown forms electron transfer highways and provides void spaces that allow for expansion and compression of the metallic species therein. Further, the well-separated few-layer graphene sheets provide an increases specific surface area, which enables short diffusion lengths and superior energy storage performance. Also as shown, the bimetal carbonate nanoparticles exhibit two or more different flower-like morphologies.

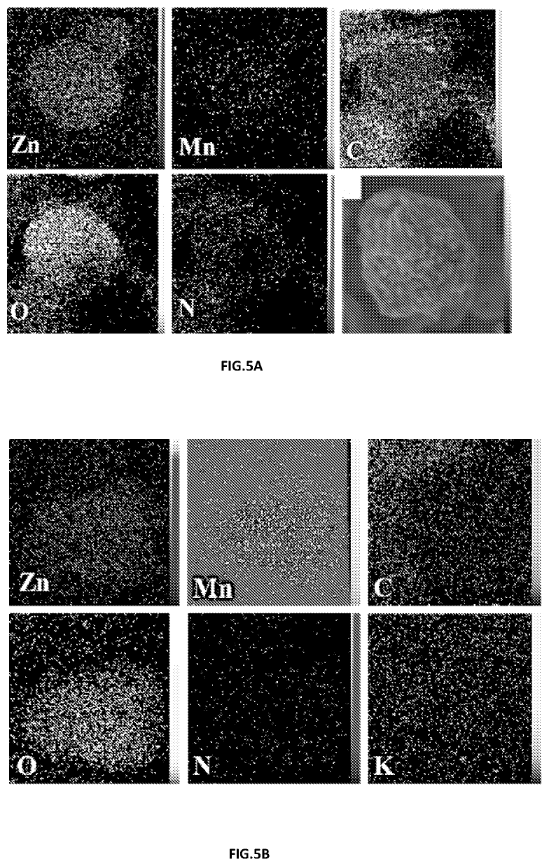

FIG. 5A shows elemental mapping images of an exemplary pristine ZMG nanocomposite. As shown, the Mn and Zn elements are uniformly distributed within a single-phase crystal, instead of two separate phases, which confirms the atomic-scale elemental distribution in the bimetallic carbonate. The increased disorder of the Mn elemental map as compared to the Zn elemental map, shows that, in some embodiments, the exemplary pristine ZMG nanocomposite comprises some single-metal carbonates or Mn-/Zn-rich bimetallic species. Further, EDX analysis of the ZMG nanocomposite (bottom-right) shows that, in some embodiments, the exemplary also shows that the exemplary pristine ZMG nanocomposite has a Zn:Mn ratio of about 2:1.

FIG. 5B shows elemental mapping images of a cycled ZMG nanocomposite. To investigate morphological variations of the negative and positive electrode active materials before and after cycling, a device after 16,000 cycles was disassembled and observed by FE-SEM (FIG. S21-S22). As can be seen, after repeated plating/stripping cycles, the aggregated metal particles of the as-prepared ZMG mostly evolved into homogeneously distributed small particles. This likely stems from the low lattice mismatch of graphene for Zn that facilitates the reversible deposition of Zn,82 resulting in a continuous gain in coulombic efficiency with cycling. The morphology of the LDHS electrode remains almost unchanged during cycling.

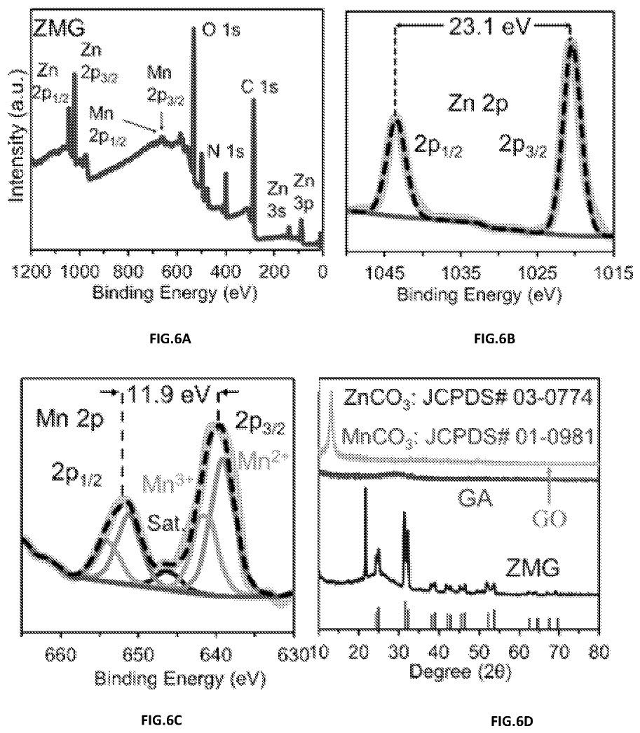

FIG. 6A shows a graph of a full survey X-ray photoelectron (XPS) spectrum of an exemplary ZMG nanocomposite and the Zn, Mn, O, N, and C elements therein. As shown, the existence of nitrogen confirms that N-doped graphene was obtained under the hydrothermal reduction in the presence of urea CO(NH₂)₂. FIG. 6B shows a graph of a high resolution core-level of Zn2p of an exemplary ZMG nanocomposite. As shown, the exemplary ZMG nanocomposite exhibits a core level Zn 2p peak that is deconvoluted into a Zn 2p_{3/2} peak with a binding energy at about 1021 eV and a Zn 2p_{1/2} peak with a binding energy of about 1044 eV. As shown, the exemplary ZMG nanocomposite exhibits a F spin-orbit splitting value of about 23 eV between Zn 2p_{3/2} and Zn 2p_{1/2}, which indicates that the elemental Zn has an oxidation state of +2 in the ZMG structure. FIG. 6C shows a graph of a high resolution core-level of Mn2p of an exemplary ZMG nanocomposite. As shown, the spectrum of an exemplary ZMG nanocomposite exhibits a first peak of about 641 eV corresponding to the spin-orbit splitting of Mn 2p_{3/2}, and a second peak of about 653 eV, corresponding to the spin-orbit splitting of Mn 2p_{1/2}. Further the energy separation of about 11.9 eV confirms the existence of Mn in its +2 oxidation state. FIG. 6D shows a graph of a high resolution core-level of graphene oxide, reduced graphene oxide, and an exemplary ZMG nanocomposite. As shown, a broad hump at about 27° 2θ and an absence of a characteristic GO peak at about 14° 2θ indicates disordering of the initial graphitic structure and the presence of few-layer graphene in the nanocomposite.

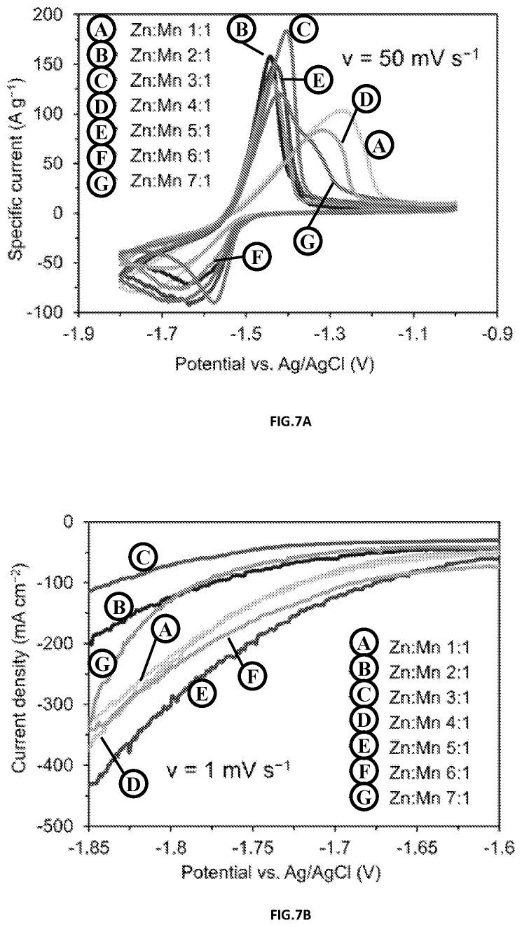

FIGS. 7A and 7B show a CV graph and an LSV graph, respectively, of an exemplary an exemplary ZMG nanocomposite with Zn:Mn molar ratios ranging from 1:1 to 7:1 recorded at a constant potential of about −1.9 V for a period of time of about 2 hours in a ZnO-saturated 6.0 M KOH electrolyte. As shown, in some embodiments, the ZMG with a Zn:Mn molar ratio of 3:1 demonstrates the best electrochemical performance as an anode material, with a more negative HER overpotential.

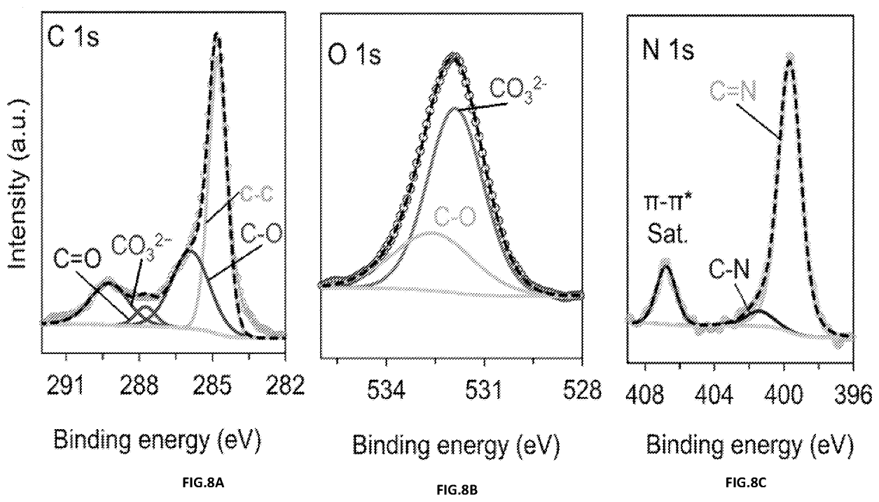

FIG. 8A shows a deconvoluted core level XPS spectra of C1s of the exemplary ZMG nanocomposite. As shown, the exemplary ZMG nanocomposite has a high-resolution C is peak that is deconvoluted into four pronounced peaks at about 288.7 eV, 286.9 eV, 285.8 eV, and 283.9 eV, which correspond to CO₃²⁻, C═O, and C—O (of the residual oxygen-containing groups), and C—C/C═C (in the rGO nanosheets), respectively. FIGS. 8B-8C show deconvoluted core level XPS spectra of O1s and N1s of the exemplary ZMG nanocomposite. As shown, the core level spectra has separated peaks at about 531.8 eV, 533.2 eV, 399.6 eV, and 401.7 eV, which correspond to CO₃²⁻, C—O, C═N, and C—N, respectively.

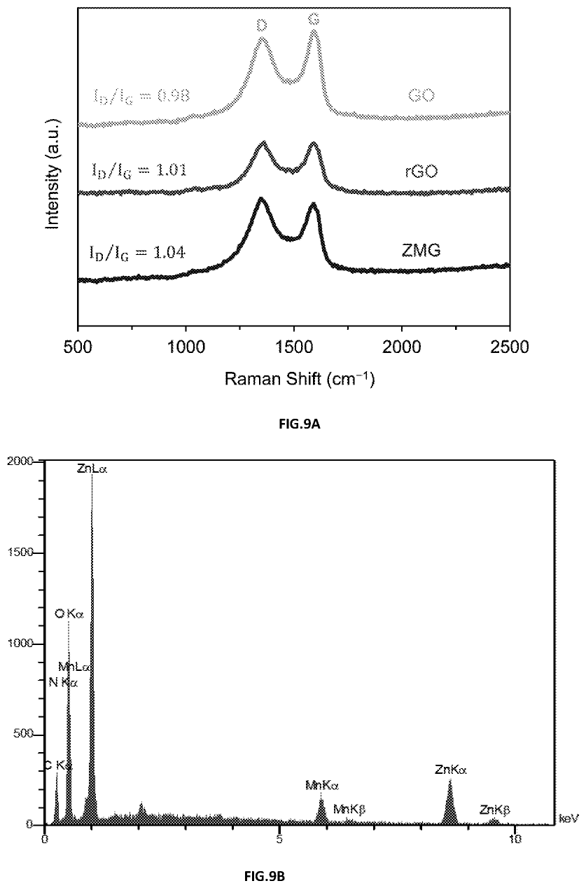

FIG. 9A shows Raman spectra of graphene oxide, reduced graphene oxide, and an exemplary ZMG nanocomposite. As shown, the Raman spectrum exhibits a D-band dominant peak at about 1350 cm-1 and a G-band dominant peak at about 1592 cm-1, which correspond to the disordered carbon and the in-plane vibration of the sp2 hybridized carbon atoms, respectively. In some embodiments, the high D/G ratio of about 1 shown therein, as compared to GO's D/G ratio of about 0.98 shows that the hydrothermal reduction, the nitrogen doping, or both, increases the number of structural defects and decrease both the number of oxygen-containing functionalities and the average size of the sp2 domains formed in the rGO. FIG. 9B shows an energy-dispersive X-ray (EDX) spectrum of an exemplary ZMG nanocomposite, wherein the Zn:Mn ratio is measured as being about 2:1.

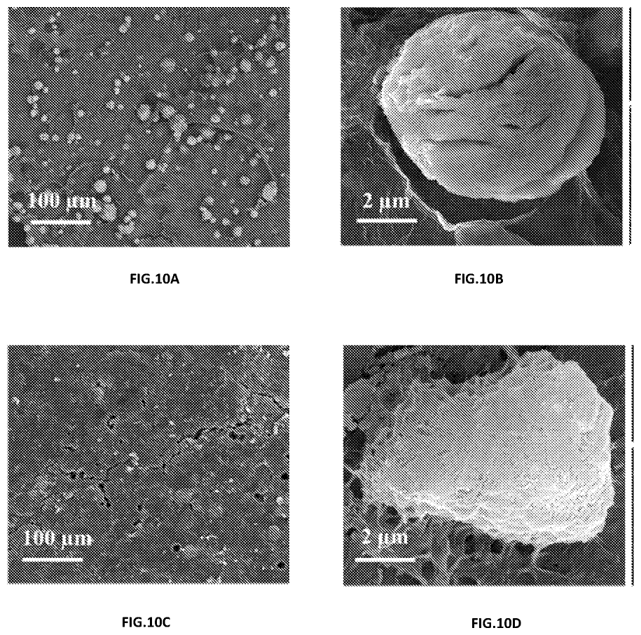

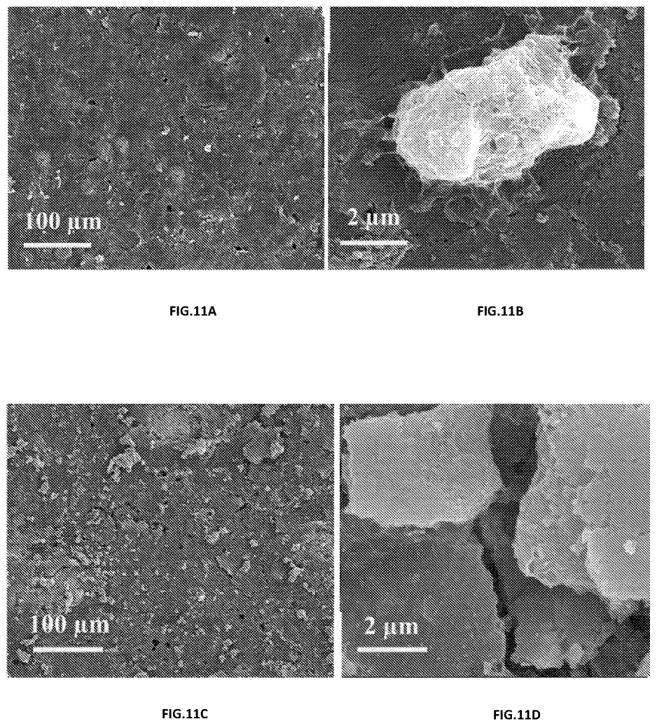

FIGS. 10A and 10C show scanning electron microscope (SEM) images of exemplary ZMG nanocomposites before 16,000 charging and discharging cycles at 10 mA/cm². FIGS. 10B and 10D show SEM images of exemplary ZMG nanocomposites after 16,000 charging and discharging cycles at 10 mA/cm². FIGS. 11A and 11B show SEM images of an exemplary third ZMG nanocomposite before and after applying regenerative pulses, respectively. FIGS. 11C and 11D show SEM images of an exemplary fourth ZMG nanocomposite before and after applying regenerative pulses, respectively. As shown, before the regenerative cycles, the surface of the graphene contains a small amount of metallic zinc particles, whereas applying the regenerative pulses drives plating of the metallic zinc and manganese oxide particles on the graphene surface without any dendrite formation.

### ZMG Electrodes

Many current Zn-based batteries require a discharge cut-off, which limits the depth of discharge to prevent the formation of zinc oxide that passivates the zinc electrode. However, as shown in the elemental mapping images, the graphene in the ZMG electrode enables zinc oxide to be reversibly plated and stripped by applying the regenerative pulses. As such, the exemplary Zn∥Ni energy storages devices herein can be charged and fully discharged for over 16,000 cycles with without energy storage performance deficits. In some embodiments, the ZMG electrodes herein are formed from the ZMG nanocomposites herein. In some embodiments, the ZMG electrodes herein comprise zinc-based mixed transition metal carbonates (ZnₓM₁₋ₓCO3), where M=Fe, Co, Al, or Mn, grafted onto a graphene scaffold to form ZnₓM₁₋ₓCO₃@G. In some embodiments, the ZMG electrodes herein comprise bimetallic Zn_{(2/3)}Mn_{(1/3)}CO₍₃₎ and a graphene scaffold.

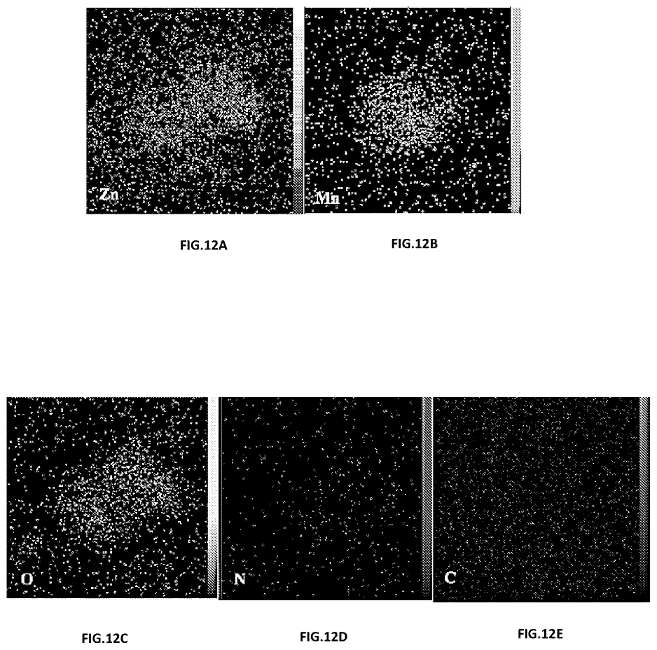

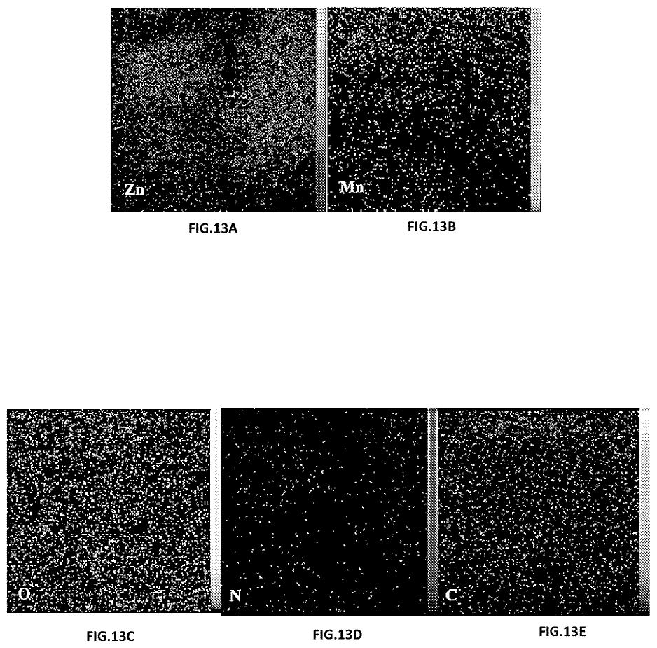

FIGS. 12A-12E show elemental mapping images of zinc, manganese, oxygen, nitrogen, and carbon in an exemplary ZMG electrode before applying the regenerative pulses. FIGS. 13A-13E show elemental mapping images of zinc, manganese, oxygen, nitrogen, and carbon in an exemplary ZMG electrode after applying the regenerative pulses. As shown, the elements are uniformly distributed both before and after applying the regenerative pulses, a thus no potentially harmful dendrites were formed.

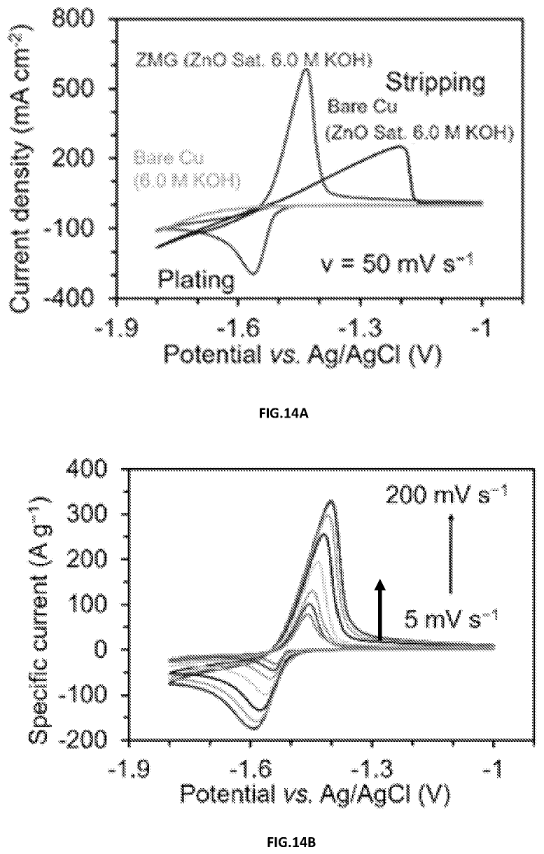

FIG. 14A shows cyclic voltammetry (CV) curves of an exemplary ZMG electrode in a ZnO saturated 6.0 M KOH electrolyte and a bare copper mesh in both 6.0 M KOH and ZnO saturated 6.0 M KOH electrolytes, at a scan rate of 50 mV/s and after about 20 CV cycles electrode activation. In some embodiments, the ZnO saturated 6.0 M KOH electrolytes comprises zincate (Zn(OH)₄)²⁻. As shown, without zincate the copper mesh lacks current in the potential range from about −1.0 V to about −1.8 V, while the CV curve of the copper mesh with the zincate electrolyte exhibits well defined and reversable Zn plating and stripping peaks, demonstrating zincate's suitability for energy storage applications.

In some embodiments, the redox reactions at the ZMG electrode in an alkaline electrolyte are:

### Oxidation:

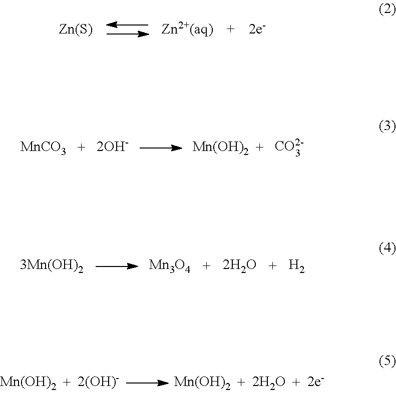

### Complexation:

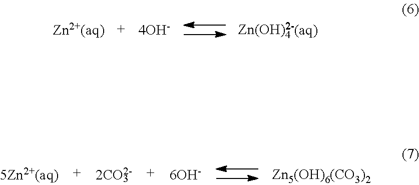

### Total:

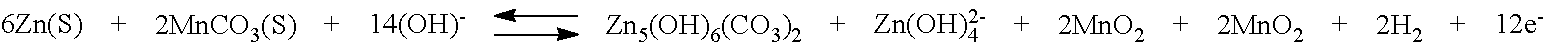

FIG. 14B shows CV curves of an exemplary ZMG electrode at scan rates from 5 mV/s to 200 mV/s. As shown, the redox peak currents and voltages are proportional the square root of the scan, and the peak potentials for the oxidation and reduction shift farther apart as the scan rate increases, which both indicate that the electrochemical kinetics of the redox reactions are well controlled.

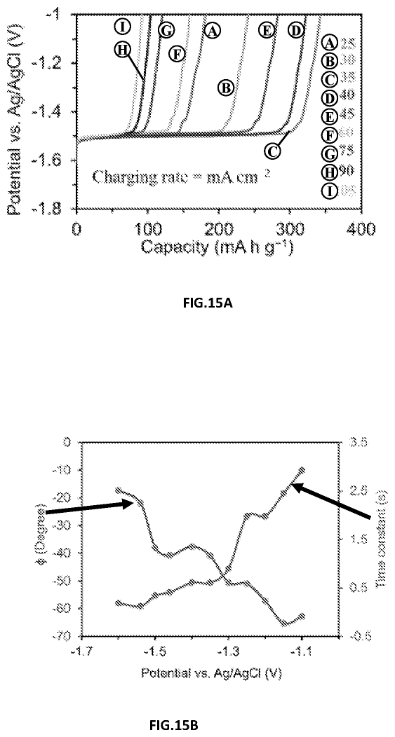

FIG. 15A shows discharge curves of an exemplary ZMG electrode at charging rates from 25 mA/cm² to 105 mA/cm² and at a discharge rate of 3 mA/cm². FIG. 15B shows a phase angle and time constant (=1/2πf) of an exemplary ZMG electrode obtained from the Bode phase plots of the ZMG nanocomposite electrode at different potentials. As shown, in the low frequency region, the phase angle of the ZMG nanocomposite increases with increasing potential and approaches the −90° expected for an ideal capacitor. Further, as shown, the time constant decreases with decreasing potential (0.19 s at −1.6 V). These results demonstrate that the exemplary ZMG nanocomposite exhibits low internal resistance, low time constant, and fast charge transfer kinetics, rendering it a suitable material for high-rate energy storage applications.

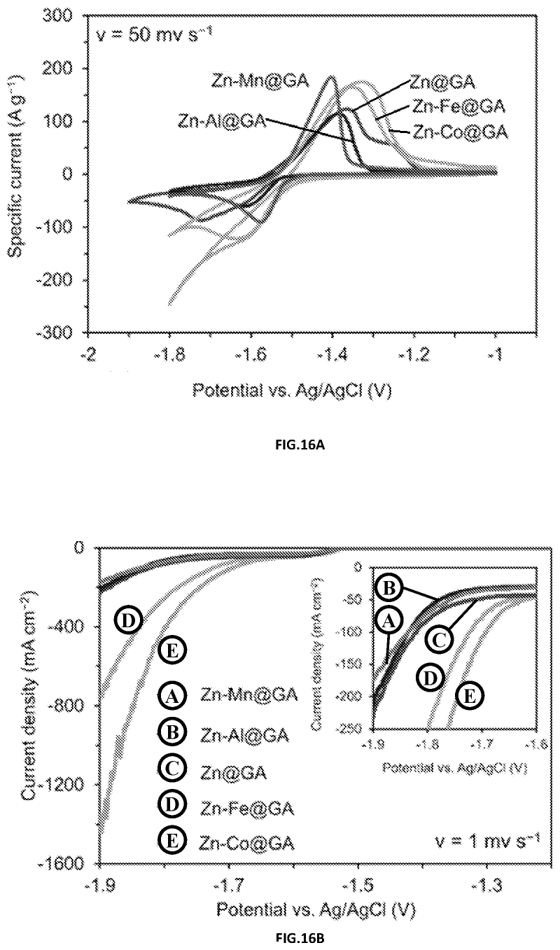

FIGS. 16A and 16B show linear sweep voltammetry (LSV) curves and CV curves of exemplary Zn@GA, Zn—Co@GA, Zn—Al@GA, Zn—Fe@GA and Zn—Mn@GA electrodes, respectively, in a 3E cell comprising an Ag/AgCl (3.0 M KCl) reference electrode, a Pt plate counter electrode, and a ZnO-saturated 6.0 M KOH electrolyte. The synthesized bimetallic carbonates exhibited superior energy storage performances when compared to the monometallic ZnCO₃@GA nanocomposite, demonstrating the increased energy storage performance of the Zn anode provided herein. As shown, in some embodiments, the Zn_{2/3}Mn_{1/3}CO₃@GA nanocomposite displays the lowest current density of about −173 mA/cm² at a voltage of about −1.9 V, greater reversibility, and a higher (i.e. more negative) overpotential for the hydrogen evolution reaction (HER). Further, as shown, the Zn@GA, Zn—Al@GA, Zn—Fe@GA, and Zn—Co@GA nanocomposite electrodes display current densities of about −240, −221, −754, and −1,390 mA/cm² at a voltage of about −1.9 V, respectively.

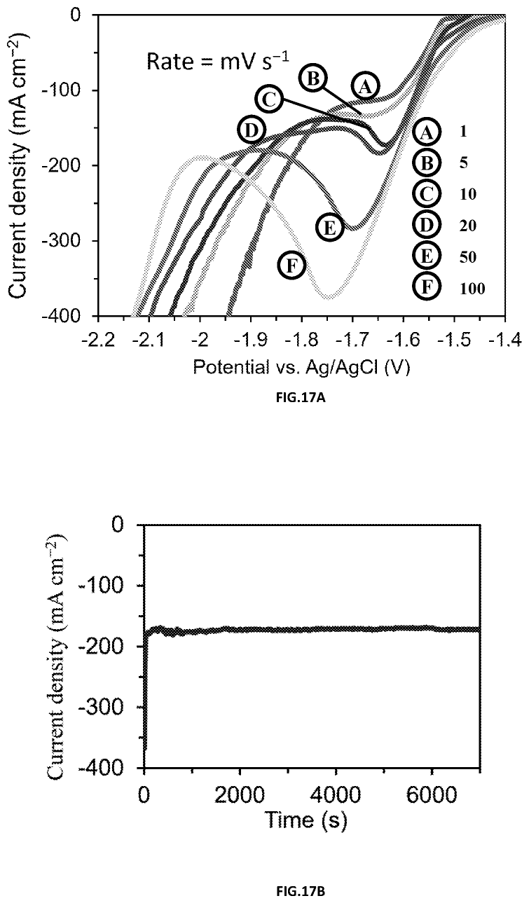

FIG. 17A shows LSV curves of an exemplary ZMG electrode at scan rates from 1 mV/s to 100 mV/s. As shown, the less pronounced curves at low charging rates may be caused by various bubbles which are generated on the electrode surface and impede the Zn plating/stripping process. Increasing the charging rate suppresses the hydrogen evolution by increasing the HER overpotential, thus leading to a higher capacity because of the more efficient Zn plating/stripping process. However, in some embodiments, at extremely high charging rates, the impeded diffusion of the electrolyte ions into the inner active sites limits performance to a maximum capacity at a charging rate of about 35 mA/cm² or about 343 mAh/g. Further, in some embodiments, the hydrogen evolution overpotential increases at high rates, which is beneficial for efficient discharging. In some embodiments, increasing the current density reduces the capacity, due to insufficient transport of the electrolyte ions into the inner active sites at higher current densities by higher degrees of polarization.

FIG. 17B shows a chronoamperometric response of an exemplary ZMG recorded at a constant potential of about −1.9 V over 2 h of operation in a ZMG electrode in a 6.0 M KOH electrolyte. As shown, the improved charge transfer properties resulting from the bimetallic synergistic effects and the more negative HER overpotential enable the increased energy storage performance of the exemplary ZMG electrode.

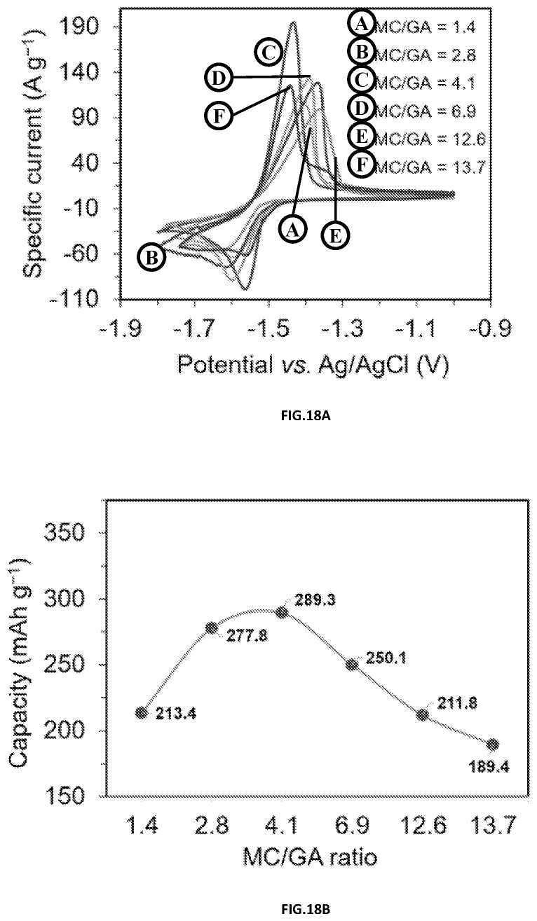

FIG. 18A shows CV curves of exemplary ZMG electrodes with metal to graphene aerogel weight percentage ratios from 1.4 to 13.7 at a scan rate of about 50 mV/s. FIG. 18B shows a graph of the capacities of exemplary ZMG electrodes with metal to graphene aerogel weight percentage ratios from 1.4 to 13.7. As shown, in some embodiments, a ZMG electrode with a metal to graphene aerogel weight percentage ratio of about 4 provides the highest capacity of about 290 mAh/g

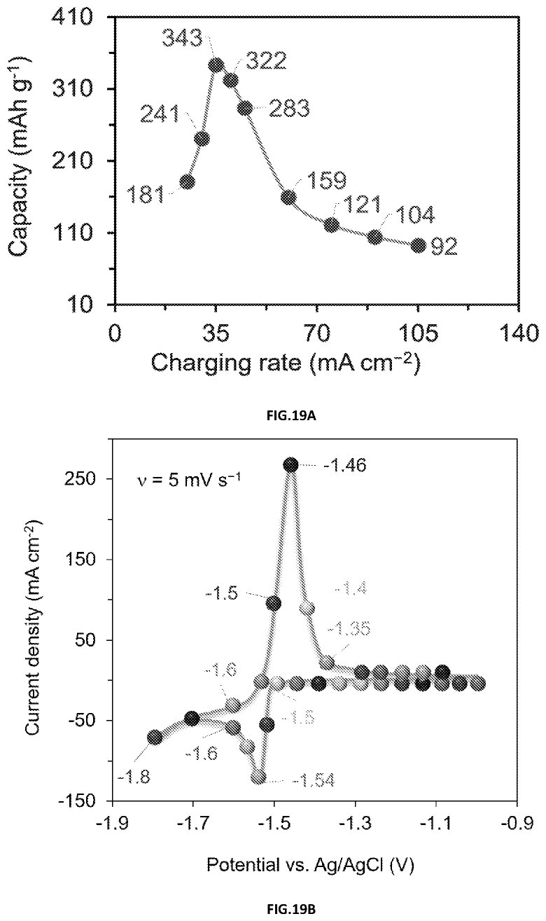

FIG. 19A shows the capacity of an exemplary ZMG electrode at charging rates from 25 mA/cm² to 105 mA/cm². In some embodiments, at extremely high charging rates, increased overpotential increments do not performance, due to the impeded diffusion of the electrolyte ions into the inner active sites. Therefore, the maximum capacity is provided at a charging rate of 35 mA cm-2, that is about 343 mAh/g.

FIG. 19B shows a CV curve of an exemplary ZMG electrode at a sweep rate of 5 mV/s, wherein points are labeled with the potential at which the impedance spectra was measured. Equivalent circuit parameters for the exemplary ZMG Electrode at the labeled points are shown in Table 1 below:

TABLE 1

| E | ESR | R1 | CPE1 | | R2 | CPE2 | W | | CPE3 | |
|---|---|---|---|---|---|---|---|---|---|---|
| (V) | (Ω) | (Ω) | (F sⁿ⁻¹) | n1 | (Ω) | (F sⁿ⁻¹) | (Ω s^{-1/2}) | n2 | F sⁿ⁻¹ | n3 |
| −1.35 | 0.189 | 0.574 | 0.455 | 0.930 | 82.46 | 0.248 | 0.171 | 0.892 | 0.946 | 0.882 |
| −1.5 | 0.184 | 0.404 | 0.655 | 0.914 | 72.24 | 0.945 | 0.608 | 0.987 | 0.342 | 0.953 |
| −1.54 | 0.181 | 0.479 | 1.138 | 0.952 | 27.31 | 1.108 | 2.039 | 0.985 | 1.289 | 0.979 |
| −1.6 | 0.187 | 0.894 | 1.082 | 0.967 | 18.32 | 2.073 | 0.246 | 0.948 | 2.022 | 0.791 |
| −1.8 | 0.173 | 0.695 | 1.258 | 0.957 | 1.681 | 2.829 | 0.0145 | 0.943 | 4.105 | 0.958 |

As shown, the resistance of about 0.18 ohms is remarkably low, enabling improved performance of the electrode.

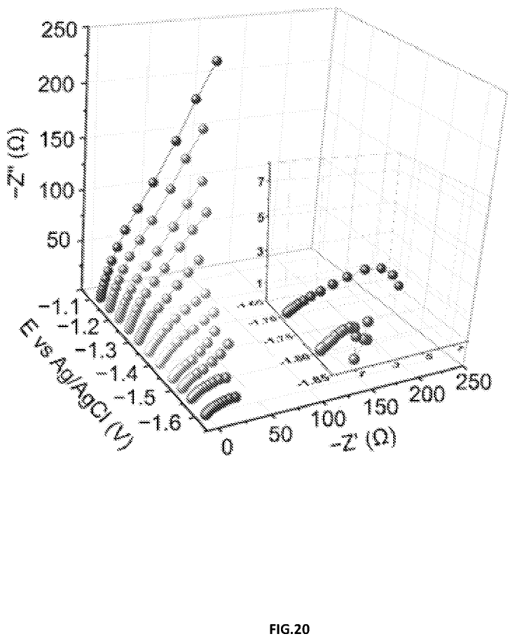

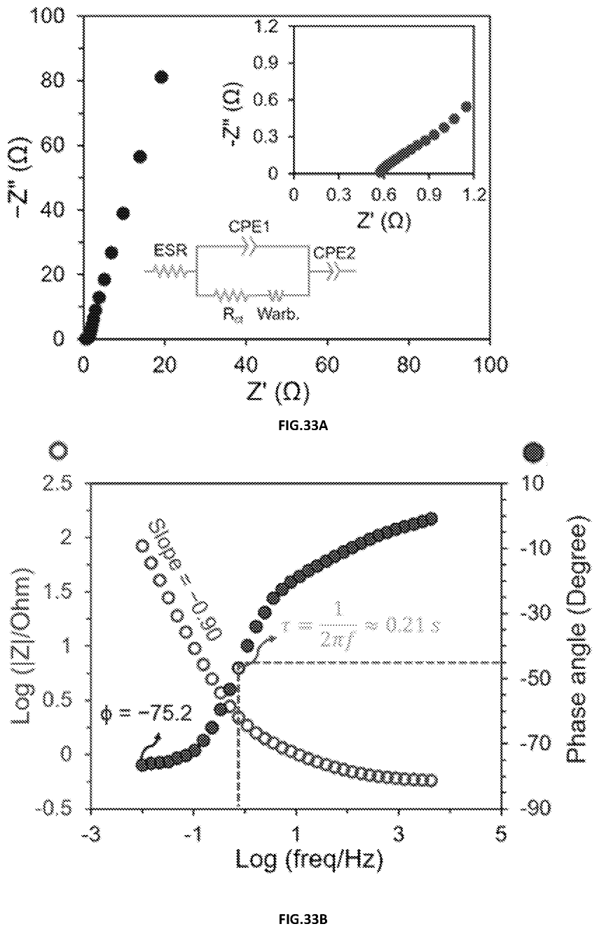

FIG. 20 shows a Nyquist plot of an exemplary ZMG electrode over a frequency range from 100 kHz to 10 mHz in a ZnO saturated 6.0 M KOH electrolyte, wherein the inset displays the Nyquist plot of the high-frequency region. In some embodiments, the X-axis intercept represents the equivalent series resistance (ESR) of the system, as shown in the lower inset in FIG. 33A. In some embodiments, as shown, at high-frequencies, the R1 arc is independent of the applied potential. This relationship may be attributed to non-Faradaic phenomena including the electrical contact resistance and distributed ionic resistance within the pores in parallel with a capacitive CPE1. In some embodiments, as shown, at medium-high frequencies, the R2 arc is potential-dependent. This relationship may be attributed to the kinetics of the electrochemical reactions (represented as the charge transfer resistance, Rct) and mass transfer processes (represented as a bounded Warburg impedance) in parallel with a capacitive CPE2. In some embodiments, at low frequencies, ion transport within the bulk of the anode material manifests as a straight line inclined at a constant angle at low frequencies (CPE3). In some embodiments, as shown, reducing the potential contracts the size of the arks until they bend onto the real axis. In some embodiments, the high frequency features remain almost unchanged. In some embodiments, the progressive contraction of the low-frequency arcs can be attributed to a transition from a metallic insulator to a metallic conductor during the stripping/plating process, due to the increase in the rate of the deposition of metallic species on the electrode surface as the potential becomes more negative. In some embodiments, the application of increased potential yields a strong expansion of the arcs at low frequencies.

### Methods of Forming a ZMG Electrode

In some embodiments, the ZMG electrodes herein were prepared by a facile one-step hydrothermal method. In some embodiments, the method comprises: (a) ultrasonicating graphene oxide in a solvent to form a first solution; (b) adding zinc nitrate hexahydrate and manganese nitrate tetrahydrate to the first solution; (c) adding a reducing agent to the first solution to form a second solution; (d) heating the second solution; (e) cooling the second solution; (f) washing the second solution; and (g) freeze drying the second solution. In some embodiments, steps (a)-(g) form a ZMG nanocomposite.

In some embodiments, the ZMG electrodes herein are prepared by a facile one-pot hydrothermal method. In some embodiments, the ZMG electrodes herein are prepared by co-precipitating mixed metal ions onto the surfaces of graphene oxide (GO). In some embodiments, the ZMG electrodes herein comprise a zinc-based mixed transition metal carbonates (ZnₓM₁₋ₓCO₃; M=Fe, Co, Al, and Mn) grafted onto a graphene scaffold nanosheets to form a ZnₓM₁₋ₓCO₃@G electrode.

In some embodiments, concentration of the graphene oxide in the first solution is about 0.5 g/L to about 10 g/L. In some embodiments, concentration of the graphene oxide in the first solution is at least about 0.5 g/L, 1 g/L, 2 g/L, 3 g/L, 4 g/L, 5 g/L, 6 g/L, 7 g/L, 8 g/L, or 9 g/L. In some embodiments, concentration of the graphene oxide in the first solution is at most about 1 g/L, 2 g/L, 3 g/L, 4 g/L, 5 g/L, 6 g/L, 7 g/L, 8 g/L, 9 g/L, or 10 g/L. In some embodiments, the graphene oxide is formed by a Hummer's method. In some embodiments, the ultrasonification is performed for about 1 minute to about 120 minutes. In some embodiments, the ultrasonification is performed for at least about 5 minutes, 10 minutes, 20 minutes, 30 minutes, 40 minutes, 50 minutes, 75 minutes, or 100 minutes. In some embodiments, the ultrasonification is performed for at most about 1 minute, 5 minutes, 10 minutes, 20 minutes, 30 minutes, 40 minutes, 50 minutes, or 75 minutes. In some embodiments, the ultrasonification is performed at room temperature.

In some embodiments, the zinc nitrate hexahydrate has a concentration of about 1 mM to about 1,000 mM. In some embodiments, the zinc nitrate hexahydrate has a concentration of at least about 1 mM, 5 mM, 10 mM, 50 mM, 100 mM, or 500 mM. In some embodiments, the zinc nitrate hexahydrate has a concentration of at most about 5 mM, 10 mM, 50 mM, 100 mM, 500 mM, or 1,000 mM. In some embodiments, the manganese nitrate tetrahydrate has a concentration of about 0.3 mM to about 300 mM. In some embodiments, the manganese nitrate tetrahydrate has a concentration of at least about 0.3 mM, 1 mM, 5 mM, 10 mM, 50 mM, 100 mM, or 200 mM. In some embodiments, the manganese nitrate tetrahydrate has a concentration of at least about 1 mM, 5 mM, 10 mM, 50 mM, 100 mM, 200 mM, or 300 mM.

In some embodiments, step (c) occurs for a period of time of at least about 0.1 hour, 0.5 hours, 1 hour, 2 hours, 3 hours, 4 hours, 5 hours, 6 hours, 7 hours, 8 hours, 9 hours, or 10 hours. In some embodiments, a molar ratio of Zn²⁺ to Mn²⁺ is about 1:1 to about 7:1. In some embodiments, the reducing/doping agent comprises urea, hydrazine hydrate, sodium borohydride, ascorbic acid, hydroquinone, sodium cholate, sodium citrate, hydroiodic acid, bovine serum albumin, dopamine, glucose, fructose, sucrose, melatonin, starch, oxalic acid, tannic acid, gallic acid, caffeic acid, or any combination thereof.

In some embodiments, the reducing agent converts the GO into an interconnected three-dimensional conductive network of reduced graphene oxide (rGO). In some embodiments, the electrostatic interactions between the negatively charged GO/rGO and the positively charged metal carbonates cause the three-dimensional conductive network to wrap around the ZnₓM₁₋ₓCO₃ nanoparticles. In some embodiments, the reducing agent converts the GO into an interconnected three-dimensional conductive network of reduced graphene oxide (rGO) without the use of a structure-directing agent. In some embodiments, the interconnected three-dimensional conductive network's structure is formed by the reducing agent. In some embodiments, formation of the three-dimensional conductive network without a structure-directing agent eliminates the need for expensive, time-intensive, and hazardous separation/template removal process. In some embodiments, the combination of single-phase crystal metal ions and atomic-scale elemental synergisms between the constituent elements improves electrochemical performance.

In some embodiments, step (d) is performed at a temperature of about 90° C. to about 200° C. In some embodiments, step (d) is performed at a temperature of at least about 90° C., 100° C., 120° C., 140° C., 160° C. or 180° C. In some embodiments, step (d) is performed at a temperature of at most about 100° C., 120° C., 140° C., 160° C. 180° C., or 200° C. In some embodiments, step (d) is performed for a period of time of about 1 hour to about 24 hours. In some embodiments, step (d) is performed for a period of time of at least about 1 hour, 2 hours, 4 hours, 6 hours, 8 hours, 10 hours, 12 hours, 16 hours, or 20 hours. In some embodiments, step (d) is performed for a period of time of at most about 2 hours, 4 hours, 6 hours, 8 hours, 10 hours, 12 hours, 16 hours, 20 hours, or 24 hours. In some embodiments, the freeze drying is performed under vacuum. In some embodiments, washing the second solution removes impurities.

In some embodiments, the method further comprises stirring the first solution before step (c), after step (c), or both. In some embodiments, stirring the first solution is performed for a period of time of about 1 minute to about 100 minutes. In some embodiments, stirring the first solution is performed for a period of time of at least about 1 minute, 2 minutes, 5 minutes, 10 minutes, 20 minutes, 30 minutes, 40 minutes, 50 minutes, 60 minutes, 70 minutes, 80 minutes, or 90 minutes. In some embodiments, stirring the first solution is performed for a period of time of at least about 2 minutes, 5 minutes, 10 minutes, 20 minutes, 30 minutes, 40 minutes, 50 minutes, 60 minutes, 70 minutes, 80 minutes, 90 minutes, or 100 minutes.

In some embodiments, the method further comprises adding a conductive additive, a binder, and a solvent to the second solution to form a slurry; coating a current collector with the slurry; and drying the slurry on the current collector. In some embodiments, the conductive additive comprises carbon black, graphene, carbon nanotubes, graphite, carbon nanofibers, or any combination thereof. In some embodiments, the binder comprises polytetrafluoroethylene, styrene butadiene rubber, carboxymethyl cellulose, polyvinylidene fluoride, or any combination thereof. In some embodiments, the solvent comprises ethanol, polyvinylidene fluoride, or any combination thereof.

In some embodiments, a ratio by mass between the ZMG nanocomposite, the conductive additive, and the binder is about 17:2:1. In some embodiments, a ratio by mass between the ZMG nanocomposite and the conductive additive is about 10:2 to about 25:2. In some embodiments, a ratio by mass between the ZMG nanocomposite and the conductive additive is at least about 10:2, 11:2, 12:2, 13:2, 14:2, 15:2, 16:2, 17:2, 18:2, 19:2, 20:2, 21:2, 22:2, 23:2, or 24:2. In some embodiments, a ratio by mass between the ZMG nanocomposite and the conductive additive is at most about 11:2, 12:2, 13:2, 14:2, 15:2, 16:2, 17:2, 18:2, 19:2, 20:2, 21:2, 22:2, 23:2, 24:2 or 25:2. In some embodiments, a ratio by mass between the ZMG nanocomposite and the binder is about 10:1 to about 25:1. In some embodiments, a ratio by mass between the ZMG nanocomposite and the binder is at least about 10:1, 11:1, 12:1, 13:1, 14:1, 15:1, 16:1, 17:1, 18:1, 19:1, 20:1, 21:1, 22:1, 23:1, or 24:1. In some embodiments, a ratio by mass between the ZMG nanocomposite and the binder is at most about 11:1, 12:1, 13:1, 14:1, 15:1, 16:1, 17:1, 18:1, 19:1, 20:1, 21:1, 22:1, 23:1, 24:1 or 25:1. In some embodiments, a ratio by mass between the conductive additive and the binder is about 0.5:1 to about 5:1. In some embodiments, a ratio by mass between the conductive additive and the binder is at least about 0.5:1, 0.75:1, 1:1, 2:1, 3:1, or 4:1. In some embodiments, a ratio by mass between the conductive additive and the binder is at most about 0.75:1, 1:1, 2:1, 3:1, 4:1, or 5:1.

In some embodiments, the slurry is dried on the current collector a temperature of about 30° C. to about 100° C. In some embodiments, the slurry is dried on the current collector a temperature of at least about 30° C., 40° C., 50° C., 60° C., 70° C., 80° C., or 90° C. In some embodiments, the slurry is dried on the current collector a temperature of at most about 40° C., 50° C., 60° C., 70° C., 80° C., 90° C., or 100° C. In some embodiments, the slurry is dried on the current collector for a period of time of about 1 hour to about 24 hours. In some embodiments, the slurry is dried on the current collector for a period of time of at least about 1 hour, 2 hours, 4 hours, 6 hours, 8 hours, 10 hours, 12 hours, 16 hours, or 20 hours. In some embodiments, the slurry is dried on the current collector for a period of time of at most about 2 hours, 4 hours, 6 hours, 8 hours, 10 hours, 12 hours, 16 hours, 20 hours, or 24 hours.

### Nickel-Cobalt-Iron Layered-Double-Hydroxides

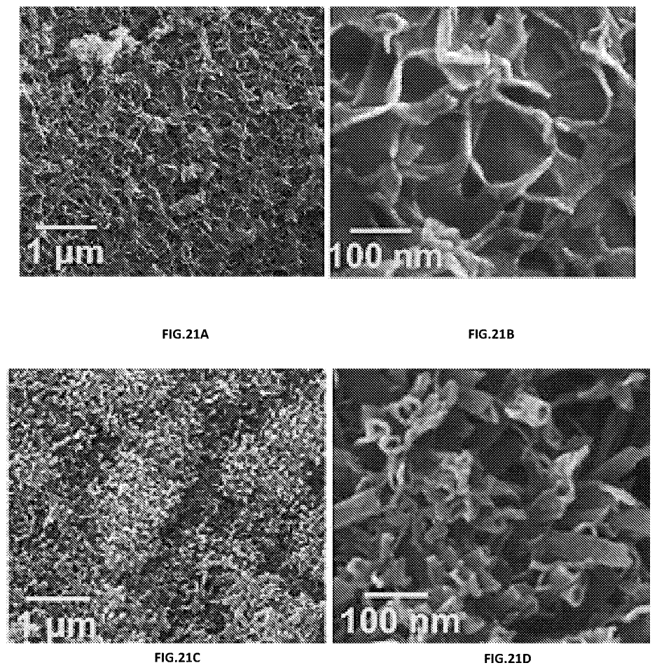

FIGS. 21A and 21B show low and high magnification SEM image of exemplary nickel-cobalt-iron layered-double-hydroxide (LDH) nano-flakes grown on a nickel foam substrate by cyclic voltammetry. As shown, in some embodiments, the LDH particles have a morphology comprising interconnected nanowalls that stand vertical to the substrate surface. FIGS. 21C and 21D show low and high magnification SEM image of an exemplary LDHS electrode hydrothermally synthesized on a nickel foam substrate. As shown, the nanowalls of the LDH, per FIGS. 21A-21B, are transformed into nanoparticles during sulfidation, through anion-exchange. In some embodiments, the nanoparticles comprise nanotubes, nanoflowers, nanodots, nanosheets, nanoclusters, or any combination thereof. In some embodiments, nanoparticles comprise nanotubes wherein the one-dimensional LDH nanotubes of the exemplary LDHS electrode provides improved accessible surface area, electrical conductivity, and ion transport pathways.

### Sulfated Nickel-Cobalt-Iron Layered-Double-Hydroxide Electrodes

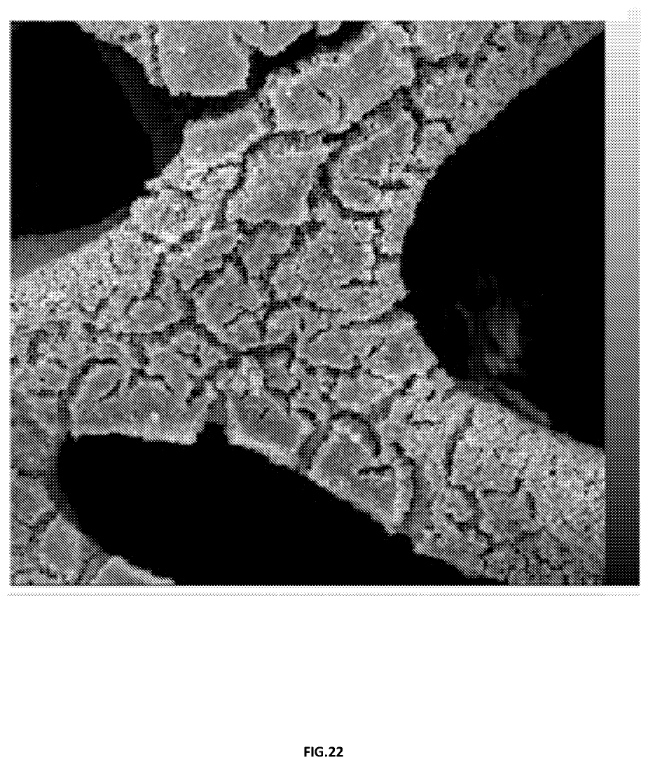

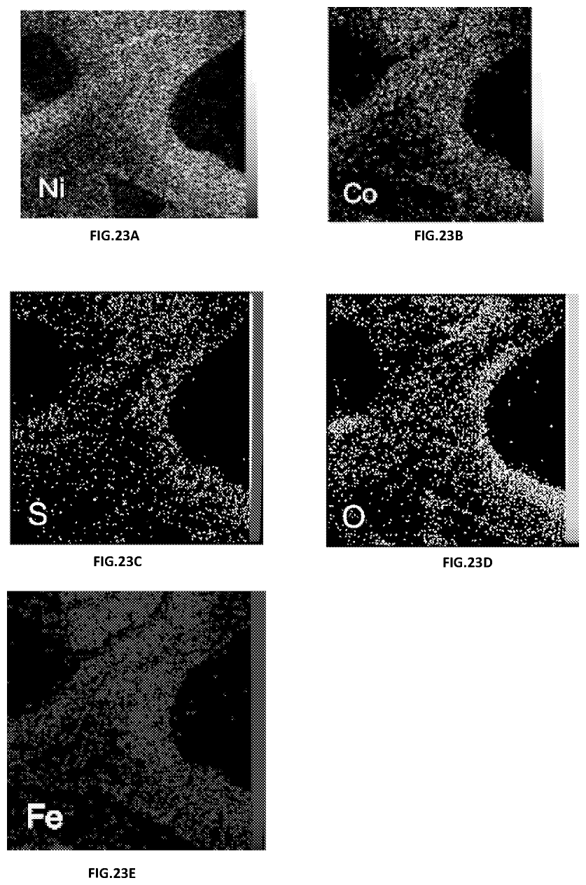

FIG. 22 shows an SEM image of a sulfated LDH (LDHS) electrode. FIGS. 23A-23E show elemental mapping images of nickel, cobalt, sulfur, oxygen, and iron in an exemplary LDHS electrode. As shown, the shows exemplary LDHS electrode exhibits a homogeneous distribution of Ni, Co, Fe, S, and O elements.

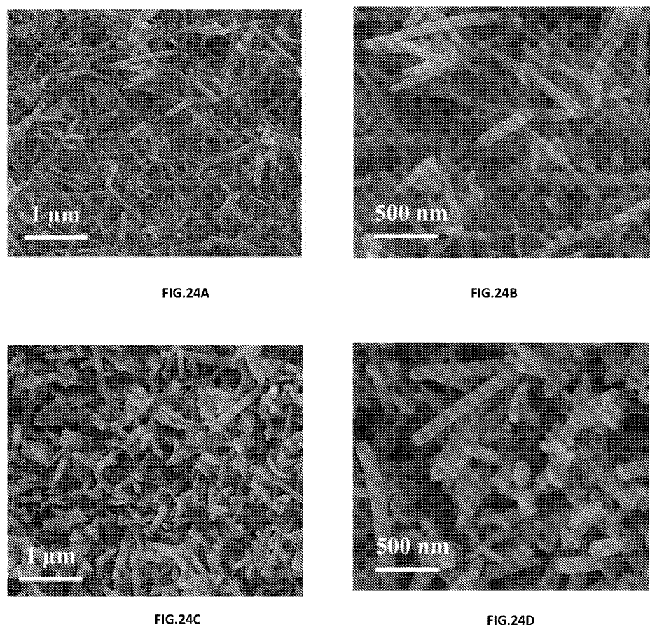

FIGS. 24A-24D show low and high magnification SEM image of an exemplary pristine LDHS electrode and an exemplary LDHS electrode after 16,000 charge-discharge cycles at a current density of 10 mA/cm². As shown, after repeated plating/stripping cycles, the aggregated metal particles form homogeneously distributed small particles, due to the low lattice mismatch of graphene for Zn, that facilitates the reversible deposition of Zn. As such, a continuous gain in coulombic efficiency is achieved with cycling and the morphology of the LDHS electrode remains almost unchanged.

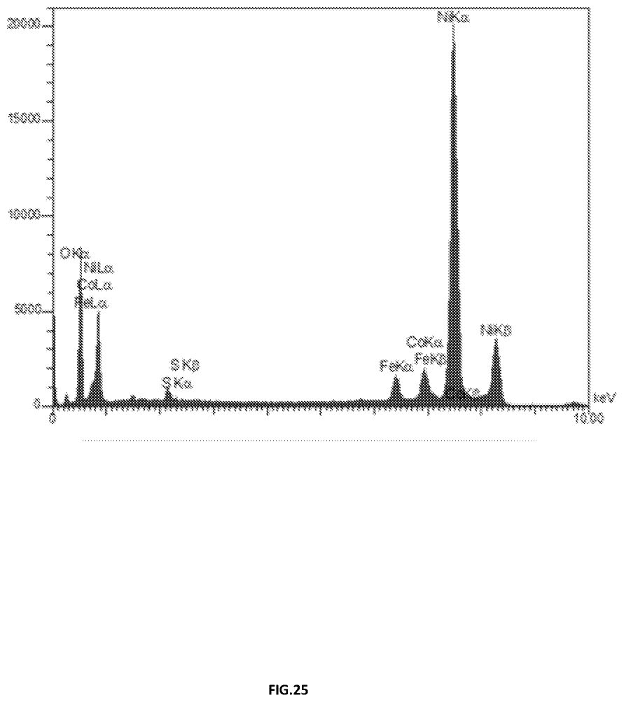

FIG. 25 shows an energy-dispersive x-ray spectroscopy (EDX) spectra of an exemplary LDHS electrode. As shown, elemental peaks related to Ni, Co, Fe, S, and O determine the distribution of Ni, Co, Fe, S, and O as constituent elements in an exemplary LDHS electrode. Particularly, FIG. 25 shows that the exemplary LDHS electrode comprises about 3.5 atomic percent of sulfur.

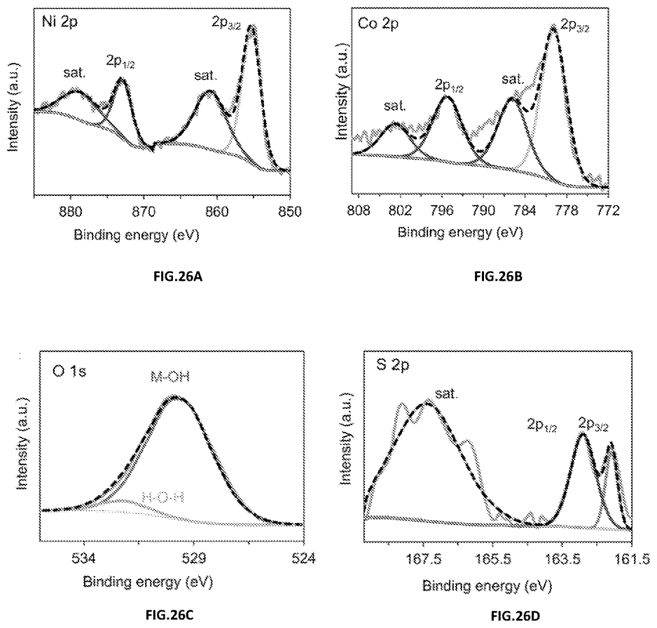

FIG. 26A shows an Ni 2p XPS spectra of an exemplary LDHS electrode. As shown, the spectrum exhibits a first spin-orbit doublet corresponding to Ni 2p_{3/2} at 855.5 eV, a second spin-orbit doublet corresponding to Ni 2p_{1/2} at 872.2 eV, and two shake-up satellites (marked as Sat.), confirming the presence of Ni in its +2 oxidation state. FIG. 26B shows an Co 2p XPS spectra of an exemplary LDHS electrode. As shown, a first peak corresponding to Co 2p_{3/2} has a binding energy of about 779, and a second peak corresponding Co 2p_{1/2} to has a binding energy of about 795.8 eV display the Co²⁺ oxidation state. FIG. 26C shows an O is XPS spectra of an exemplary LDHS electrode. In some embodiments, the peak at about 529.2 eV corresponding to M-O—H from the M(OH)₆ species, along with another peak at about 532.1 eV corresponding to H—O—H. FIG. 26D shows an S 2p XPS spectra of an exemplary LDHS electrode. As shown, the spectra exhibits a first peak with a binding energy of about 162 eV corresponding to S 2p_{3/2}, and a second peak with a binding energy of about 163 eV, corresponding to S 2p_{1/2}. The XPS spectra, per FIGS. 26A-26D, demonstrate the existence of metal-sulfur bonds in an exemplary LDHS electrode, and a lack of the original LDH structure, which forms a mixture of metal sulfides/oxides during sulfidation.

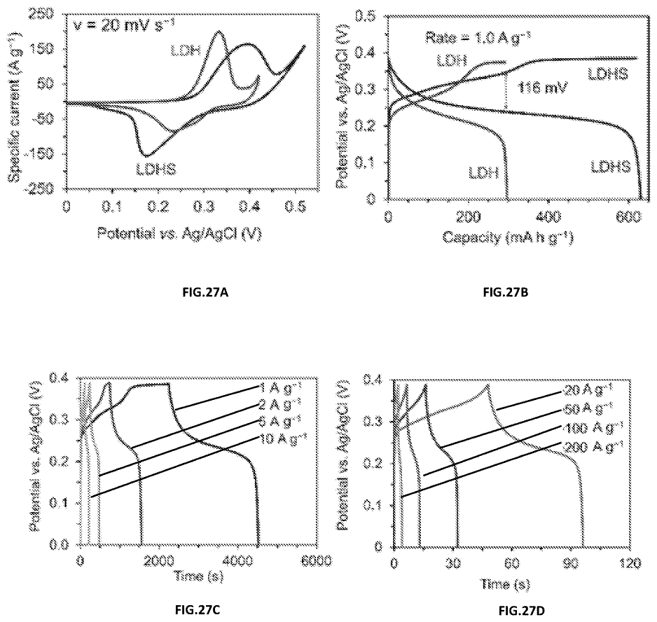

FIG. 27A shows CV curves of exemplary LDH nano-flakes and an exemplary LDHS electrode. As shown, the CV curve exhibits two redox peaks located at about 0.39 mV and about 0.18 mV. The storage mechanism of the LDHS electrode (which is comprised of a rich mixture of different metal sulfides/oxides) in an alkaline electrolyte can be attributed to the following reactions:

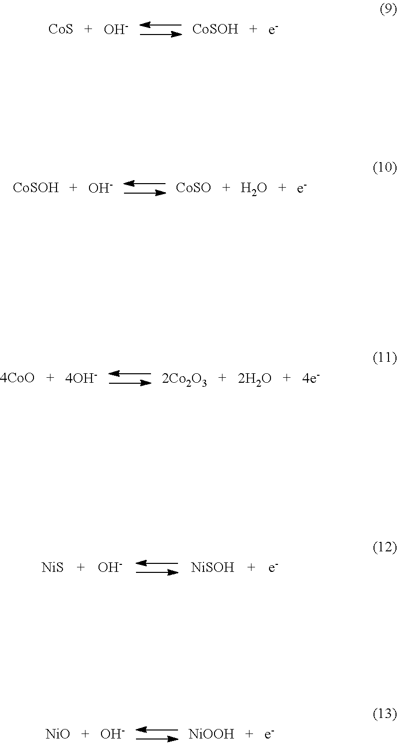

FIG. 27B shows charge-discharge profiles of exemplary LDH nano-flakes and an exemplary LDHS electrode. As shown, the profile plateaus demonstrate the non-capacitive Faradaic character of the charge storage processes. In some embodiments, the LDHS electrode delivers a discharge capacity of about 632 mAh/g, which is more than 2 times greater than that of the pristine LDH electrode (~297 mAh/g) at the charge-discharge rate of about 1.0 A/g. Further, as shown, in some embodiments, the LDHS electrode exhibits a very low voltage hysteresis, with a voltage gap of about 116 mV between charge and discharge steps, demonstrating the fast kinetics of the redox processes. The hysteresis of the LDHS electrode approaches that of a typical intercalation electrode material (e.g. several tens of mV) and is greatly improved compared to conventional electrodes in Li—O2 and Li—S batteries with voltage gaps from about 200 mV to about 2.0 V. Further, the low voltage drop implies improved compositional homogeneity of the LDHS electrode's active materials and improved ionic and electrical transport properties.

FIG. 27C shows charge-discharge profiles of an exemplary LDHS electrode, at specific current values of 1 A/g, 2 A/g, 5 A/g, and 10 A/g. FIG. 27D shows charge-discharge profiles of an exemplary LDHS electrode, at specific current values of 20 A/g, 50 A/g, 100 A/g, and 200 A/g. As shown, the IR drop of the is LDHS electrode is low even at the very high specific current of 200 A/g, indicating high conductivity and low internal resistance. The excellent coulombic efficiency of 99% (at a specific current of >5 A/g) indicates the superior reversibility of the redox processes at the LDHS electrode. As shown, even at extremely high specific currents of 200 A/g, the exemplary LDHS electrode retains a significantly high percentage of its charge capacity at 1 A/g of about 18.5%.

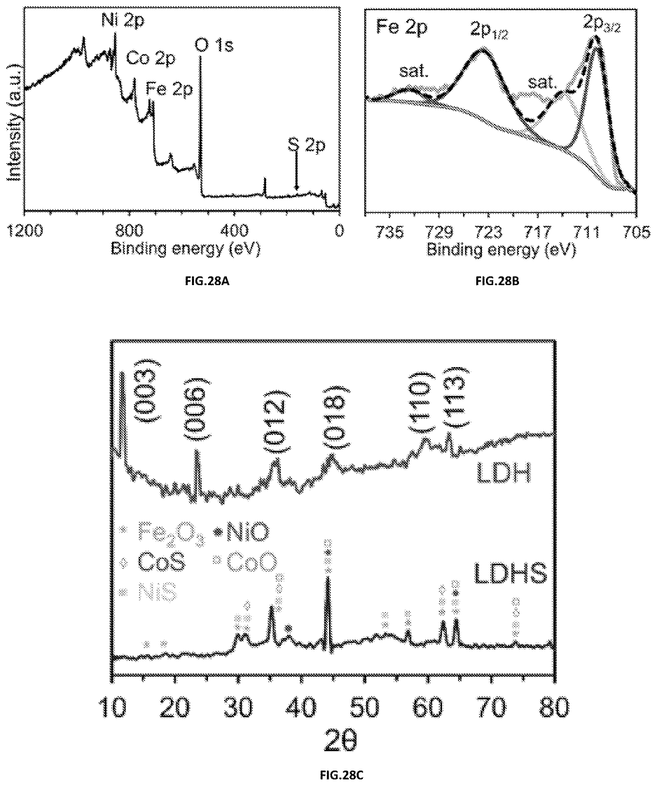

FIG. 28A shows an full survey XPS spectrum of an exemplary LDHS electrode. As shown, the LDHS structure consists of Ni, Co, Fe, 0, and S elements. FIG. 28B shows a high resolution core-level Fe 2P XPS spectrum of an exemplary LDHS electrode. As shown, shows the core-level XPS spectrum has a Fe 2p_{3/2} energy peak at about 710 eV, and a Fe 2p_{1/2} peak at about 723.1 eV. In some embodiments, the position of the peaks and the spin-orbit separation of about 13.1 eV along with the presence of a satellite band at 714.8 eV indicates that Fe is in its +3 oxidation state. As that the general formula for the LDHs is:

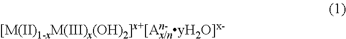

in which M(II) is a divalent metal, M(III) is a trivalent metal, and Aⁿ⁻ is an n-valent anion, the XPS spectrum shows that Ni and Co are the divalent metals and Fe is the trivalent metal in the parent Ni—Co—Fe LDH structure. Further, the XPS spectrum shows that the counter-anion in the LDH structure (Aⁿ⁻) is the nitrate anion (NO³⁻) as nickel, cobalt, and ferric nitrates were used as the metal precursors for the preparation of the exemplary LDH structure. FIG. 28C shows a XRD spectrum of an exemplary LDH and an exemplary LDHS electrode. The peaks in the XRD pattern of the LDHS structure can be indexed to: Fe₂O₃ (JCPDS No.: 00-024-0081), CoS (JCPDS No.: 01-075-0605), NiS (JCPDS No.: 01-077-1624), NiO (JCPDS No.: 00-044-1159), and CoO (JCPDS No.: 01-075-0418). In some embodiments, the peaks therein at about 11.5°, 23.6°, 36.5° and 44.2° 2θ represent the (003), (006), (012) and (018) planes, respectively. Further, the exemplary LDH exhibits common binary peaks at about 60 degrees and about 63 degrees. Additionally, the XRD pattern confirms that the exemplary LDH structure is similar to that of brucite and that the crystal structure of the LDHS lacks the organized layered structure of the LDH, wherein sulfidation transforms the LDH into a mixture of the Fe₂O₃ (JCPDS No. 00-024-0081), CoS (JCPDS No. 01-075-0605), NiS (JCPDS No. 01-077-1624), NiO (JCPDS No.: 00-044-1159), and CoO (JCPDS No. 01-075-0418) structures.

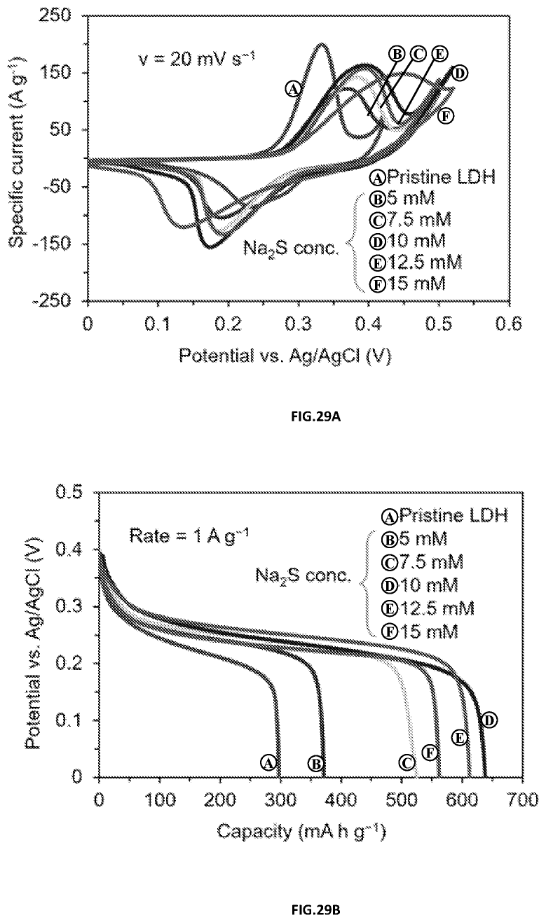

FIGS. 29A and 29B show CV curves and galvanic discharge-charge (GCD) curves, respectively, of exemplary LDH and exemplary LDHS electrode samples sulfidated in the presence of 5 mM, 7.5 mM, 10 mM, 12 mM, and 15 mM Na2S. The CV and GCD curves therein were recorded after about 50 CV cycles to activate the electrodes. As shown, the exemplary LDH and LDHS electrodes sulfidated in the presence of a 10 mM Na2S solution exhibited the best energy storage performance, wherein the area under each curve is directly proportional to charge storage capacity.

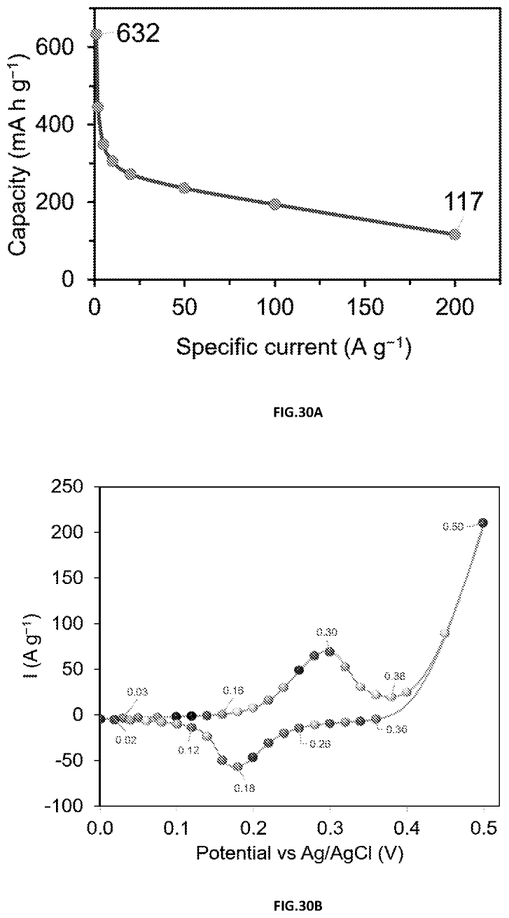

FIG. 30A shows a graph of specific capacity versus specific current for an exemplary LDHS electrode. In some embodiments, the excellent electrochemical performance of the exemplary LDHS positive electrode is enabled by a strong adhesion of the electrode active materials to the substrate, which reduces the ohmic drop. In some embodiments, the excellent electrochemical performance of the exemplary LDHS positive electrode is further enabled by the nanotubular morphology of the LDHS material, which not only provides a considerably high surface area and numerous active sites for the Faradaic redox reactions, but also enables electrolyte penetration into the interior surfaces of the electrode active materials. In some embodiments, the excellent electrochemical performance of the exemplary LDHS positive electrode are further enabled by its nanoparticle morphology, which serves as ion-buffering reservoirs, retarding the diffusion of electrolyte ions out of the electrode, thus enhancing the rate capability. FIG. 30B shows a CV curve of an exemplary LDHS electrode at a sweep rate of 5 mV/s. Equivalent circuit parameters for the exemplary LDHS electrode are listed in Table 2 below:

TABLE 2

| E | ESR | R1 | CPE1 | | R2 | CPE2 | W | | CPE3 | |
|---|---|---|---|---|---|---|---|---|---|---|
| (V) | (Ω) | (Ω) | (F sⁿ⁻¹) | n1 | (Ω) | (F sⁿ⁻¹) | (Ω s^{-1/2}) | n2 | F sⁿ⁻¹ | n3 |
| 0.02 | 0.629 | 0.445 | 0.238 | 0.924 | 3920 | 0.0041 | 0.102 | 0.912 | 0.132 | 0.812 |
| 0.03 | 0.705 | 0.446 | 0.030 | 0.871 | 3208 | 0.0034 | .005.01 | 0.897 | 0.063 | 0.881 |
| 0.16 | 0.724 | 0.409 | 0.032 | 0.914 | 953.5 | 0.0091 | 0.024 | 0.796 | 0.647 | 0.846 |
| 0.3 | 0.671 | 0.392 | 0.412 | 0.948 | 11.08 | 8.063 | 1.218 | 0.984 | 1.057 | 0.955 |
| 0.38 | 0.652 | 0.429 | 0.285 | 0.933 | 8.101 | 257.2 | 0.011.37 | 0.987 | 9.251 | 0.857 |

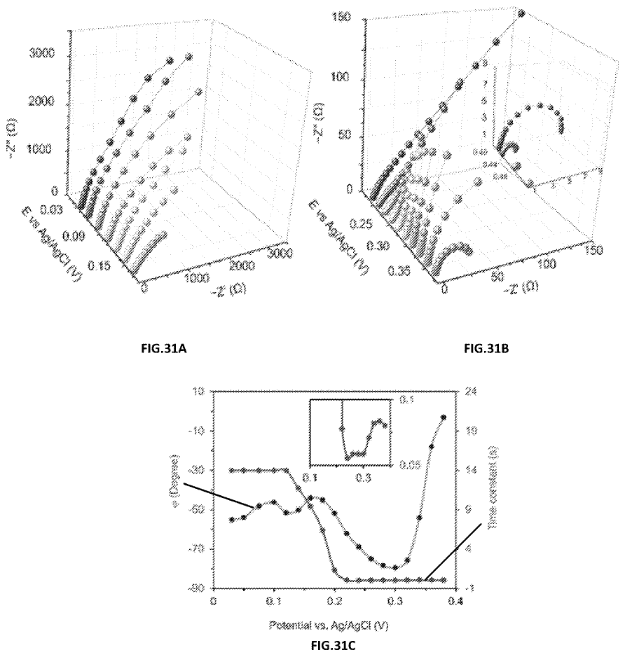

FIGS. 31A and 31B show a Nyquist plots of an exemplary LDHS electrode. The ESR value for the exemplary LDHS electrode shown therein is about 0.65Ω, indicating a low resistance for the sulfidated electrode. In some embodiments, the high frequency arcs are independent of the applied potentials and represent non-Faradaic phenomena including the electrical contact resistance and distributed ionic resistance within the pores in parallel with a capacitive CPE1. In some embodiments, as shown therein, the arcs are reduced at high frequencies, wherein the negligible interfacial impedance at the Ni foam/LDHS interface may be ascribed to the intimate contact enabled by the direct electrodeposition of the LDH onto the Ni foam substrate. In some embodiments, the overlapping arcs in the medium-high frequency and high frequency ranges may be attributed to the electron transport within the LDHS particles. In some embodiments, electron transport within the LDHS particles are a limiting kinetic step for the metal oxide/sulfide species (e.g., Fe₂O₃, CoO, CoS, NiO, NiS) with low electronic conductivities. In some embodiments, ion transport within the bulk of the cathode material is shown in straight inclined arcs at low frequencies, indicating that the mass transport limitation may gradually dominate the mechanism and the capacitive behavior may become negligible.

A first region is shown from 0 V to about 0.2 V, which is the reduction peak potential. A second region is also shown from about 0.2 V to 0.3 V, which is the interval between the reduction and the oxidation peak potentials. Further, a third region is shown from about 0.3 V to 0.5 V. As shown, the second region displays a typical mixed charge transfer/mass transport-controlled behavior followed by a part with a steeper slope at low frequencies. The large arcs at high frequencies can be attributed to kinetic limitations as well as mass transport in the electrode material, whereas the linear part at low frequencies can be ascribed to mass transport in the electrolyte. The slope of the linear segment at lower frequencies increases with increasing the potential, signifying that the ion adsorption dominates the mechanism.

As shown in the third region, with increasing potential the charge transfer resistance decreases as water transport through the material and the formation of the OER intermediates on the electrode surface. At very low frequencies and when sweeping the potential towards more negative potentials (i.e., the reduction branch of the CV), the Nyquist plot is accompanied by an inductance response due to the adsorption of ions on the electrode.

FIG. 31C shows the phase angle and time constant of an exemplary LDHS electrode at different potentials. As shown, the exemplary LDHS electrode exhibits a low internal resistance, a low time constant of less than about 0.1 seconds, fast charge transfer kinetics, and a capacitive behavior at low frequencies, this showing the exemplary electrode's suitability for high-rate energy storage applications.

### Methods of Forming a Ni—Co—Fe Electrode

Another aspect provided herein is a method of forming a Ni—Co—Fe electrode. In some embodiments, the method comprises: (a) synthesizing Ni—Co—Fe layer double hydroxide nanoplatelets; (b) heating the Ni—Co—Fe layer double hydroxide nanoplatelets; and (c) drying the Ni—Co—Fe layer double hydroxide nanoplatelets.

In some embodiments, step (a) comprises: immersing a metal foam in an acid; (b) washing the metal foam; (c) electrodepositing the metal foam in a electrosynthesis solution; and (d) washing the Ni—Co—Fe layer double hydroxide nanoplatelets on the metal foam. In some embodiments, the metal foam comprises a nickel foam.

In some embodiments, the washing is performed for a period of time of about 1 minute to about 10 minutes. In some embodiments, the washing is performed for a period of time of at least about 1 minute, 2 minutes, 3 minutes, 4 minutes, 5 minutes, 6 minutes, 7 minutes, 8 minutes, or 9 minutes. In some embodiments, the washing is performed for a period of time of at most about 2 minutes, 3 minutes, 4 minutes, 5 minutes, 6 minutes, 7 minutes, 8 minutes, 9 minutes, or 10 minutes.

In some embodiments, the electrodeposition is performed by a three-electrode (3E) cell comprising: the metal foam as a working electrode; a reference electrode; and a counter electrode. In some embodiments, the reference electrode comprises Ag/AgCl, Hg/HgO, saturated calomel, or any combination thereof. In some embodiments, the counter electrode comprises platinum, gold, carbon, graphite, or any combination thereof. In some embodiments, the acid comprises HCl, HNO₃, or both.

In some embodiments, the electrodeposition is performed by applying two or more consecutive potential cycles. In some embodiments, the electrodeposition is performed by applying about 10 to about 15 consecutive potential cycles. In some embodiments, the electrodeposition is performed by applying about 10, 11, 12, 13, 14, or 15 consecutive potential cycles. In some embodiments, the electrodeposition is performed for a period of time of less than about 5 minutes, 4 minutes, 3 minutes, 2 minutes, or 1 minute.

In some embodiments, the electrodeposition is performed at a voltage of from about −0.5 V to about −1.5 V. In some embodiments, the electrodeposition is performed at a voltage of from about −0.5 V to about −0.6 V, about −0.5 V to about −0.7 V, about −0.5 V to about −0.8 V, about −0.5 V to about −0.9 V, about −0.5 V to about −1 V, about −0.5 V to about −1.1 V, about −0.5 V to about −1.2 V, about −0.5 V to about −1.3 V, about −0.5 V to about −1.4 V, about −0.5 V to about −1.5 V, about −0.6 V to about −0.7 V, about −0.6 V to about −0.8 V, about −0.6 V to about −0.9 V, about −0.6 V to about −1 V, about −0.6 V to about −1.1 V, about −0.6 V to about −1.2 V, about −0.6 V to about −1.3 V, about −0.6 V to about −1.4 V, about −0.6 V to about −1.5 V, about −0.7 V to about −0.8 V, about −0.7 V to about −0.9 V, about −0.7 V to about −1 V, about −0.7 V to about −1.1 V, about −0.7 V to about −1.2 V, about −0.7 V to about −1.3 V, about −0.7 V to about −1.4 V, about −0.7 V to about −1.5 V, about −0.8 V to about −0.9 V, about −0.8 V to about −1 V, about −0.8 V to about −1.1 V, about −0.8 V to about −1.2 V, about −0.8 V to about −1.3 V, about −0.8 V to about −1.4 V, about −0.8 V to about −1.5 V, about −0.9 V to about −1 V, about −0.9 V to about −1.1 V, about −0.9 V to about −1.2 V, about −0.9 V to about −1.3 V, about −0.9 V to about −1.4 V, about −0.9 V to about −1.5 V, about −1 V to about −1.1 V, about −1 V to about −1.2 V, about −1 V to about −1.3 V, about −1 V to about −1.4 V, about −1 V to about −1.5 V, about −1.1 V to about −1.2 V, about −1.1 V to about −1.3 V, about −1.1 V to about −1.4 V, about −1.1 V to about −1.5 V, about −1.2 V to about −1.3 V, about −1.2 V to about −1.4 V, about −1.2 V to about −1.5 V, about −1.3 V to about −1.4 V, about −1.3 V to about −1.5 V, or about −1.4 V to about −1.5 V, including increments therein.

In some embodiments, the electrodeposition is performed at a scan rate of about 1 mV/s to about 1,000 mV/s. In some embodiments, the electrodeposition is performed at a scan rate of at least about 1 mV/s, 2 mV/s, 5 mV/s, 10 mV/s, 50 mV/s, 100 mV/s, or 500 mV/s. In some embodiments, the electrodeposition is performed at a scan rate of at most about 2 mV/s, 5 mV/s, 10 mV/s, 50 mV/s, 100 mV/s, 500 mV/s, or 1,000 mV/s.

In some embodiments, the electrosynthesis solution comprises Co(NO3)2·6H₂O, Ni(NO3)2·6H₂O, Fe(NO3)₃·9H₂O, and KNO₃. In some embodiments, a molar ratio of M(II):M(III) is about 3:1. In some embodiments, the molar concentration of KNO₃ equals the sum of the concentrations of M(II) (Co²⁺ and Ni²⁺) and M(III) (Fe³⁺) species. In some embodiments, in a 6.0 M KOH solution, ZnO dissolves into the electrolyte as zincate, Zn(OH)₄²⁻ ions.

In some embodiments, the method further comprises drying the Ni—Co—Fe layer double hydroxide nanoplatelets on the metal foam. In some embodiments, drying the Ni—Co—Fe layer double hydroxide nanoplatelets on the metal foam is performed at a temperature of about 30° C. to about 100° C. In some embodiments, drying the Ni—Co—Fe layer double hydroxide nanoplatelets on the metal foam is performed at a temperature of at least about 30° C., 40° C., 50° C., 60° C., 70° C., 80° C., or 90° C. In some embodiments, drying the Ni—Co—Fe layer double hydroxide nanoplatelets on the metal foam is performed at a temperature of at most about 40° C., 50° C., 60° C., 70° C., 80° C., 90° C., or 100° C. In some embodiments, drying the Ni—Co—Fe layer double hydroxide nanoplatelets on the metal foam is performed for a period of time of about 1 hour to about 24 hours. In some embodiments, the Ni—Co—Fe layer double hydroxide nanoplatelets is heated at a temperature of about 90° C. to about 200° C. In some embodiments, the Ni—Co—Fe layer double hydroxide nanoplatelets is heated for a time period of about 1 hour to about 24 hours. In some embodiments, the Ni—Co—Fe layer double hydroxide nanoplatelets are dried at room temperature. In some embodiments, the method further comprises washing the Ni—Co—Fe layer double hydroxide nanoplatelets before heating the Ni—Co—Fe layer double hydroxide nanoplatelets. In some embodiments, the method is performed in less than about 5 minutes.

In some embodiments, the method further comprises sulfidating the Ni—Co—Fe layer double hydroxide nanoplatelets. In some embodiments, sulfidating the Ni—Co—Fe layer double hydroxide nanoplatelets comprises heating the Ni—Co—Fe layer double hydroxide nanoplatelets in the presence of a sulfidizing agent. In some embodiments, the sulfidizing agent comprises Na2S. In some embodiments, the heating is performed at a temperature of about 100° C. to about 180° C. In some embodiments, the heating is performed for a period of time of about 4 hours to about 12 hours.

### Zinc-Nickel Energy Storage Devices

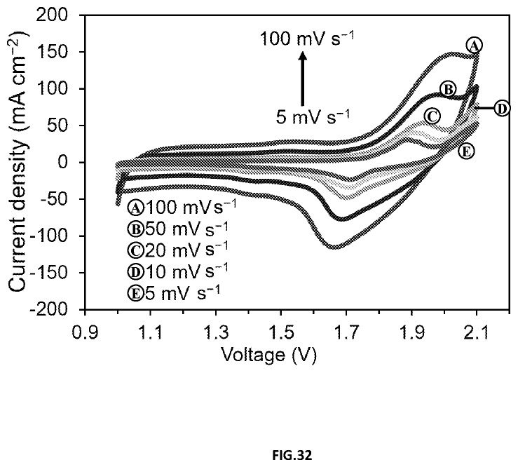

FIG. 32 shows CV curves of an exemplary zinc-nickel (Zn∥Ni) energy storage device. As shown, even at high scan rates of about 100 mV/s the shape of the CV curves remains consistent, confirming the good reversibility and rate capability of the device.

FIG. 33A shows a Nyquist plot of an exemplary Zn∥Ni energy storage device. As shown, the plot exhibits a semicircle at high frequency followed by a near-vertical line at low frequency, which confirms a combined battery-supercapacitor behavior. According to the Nyquist plot, the low ESR value of about 0.57Ω and a R_{ct} of about 0.64Ω indicate the fast reaction kinetics and excellent electrochemical activity of the device. FIG. 33B shows a Bode plot of an exemplary Zn∥Ni energy storage device. The significantly low time constant of about 0.21 seconds indicates the excellent charge-discharge rate performance of the exemplary device. Further, the phase angle of about −75.2° and the slope of about −0.9 in the low frequency region, demonstrate that the device herein exhibits a mixed supercapacitor-battery behavior, rendering it a suitable system for high-rate energy storage applications.

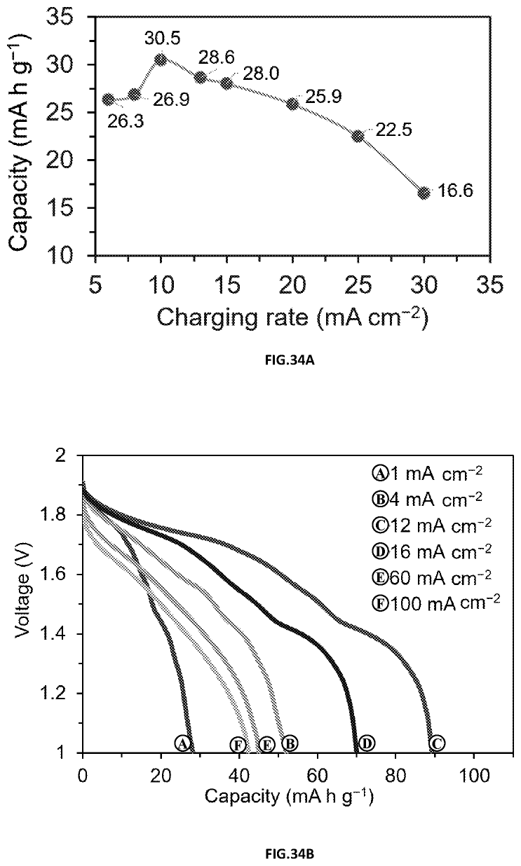

FIG. 34A shows a graph of charge rate vs capacity of an exemplary Zn∥Ni energy storage device. The charging rate is an important performance parameter of energy storage devices. As shown, in some embodiments, charging the exemplary device at a rate of about 10 mA/cm² enables the best energy storage performance. FIG. 34B shows a graph of voltage vs capacity of an exemplary Zn∥Ni energy storage device at charge rates from 1 mA/cm² to 100 mA/cm². As shown, the exemplary device exhibits a high-rate capability enabled by its supercapacitor-battery hybrid characteristics. According to the profiles, the discharge plateau decreases with increasing current rate, wherein the discharge plateau of the Zn∥Ni battery is about 1.8 V, which is a high compared with current aqueous Zn-based batteries. Further, as shown, the charge-discharge profiles exhibit an increasing polarization effect.

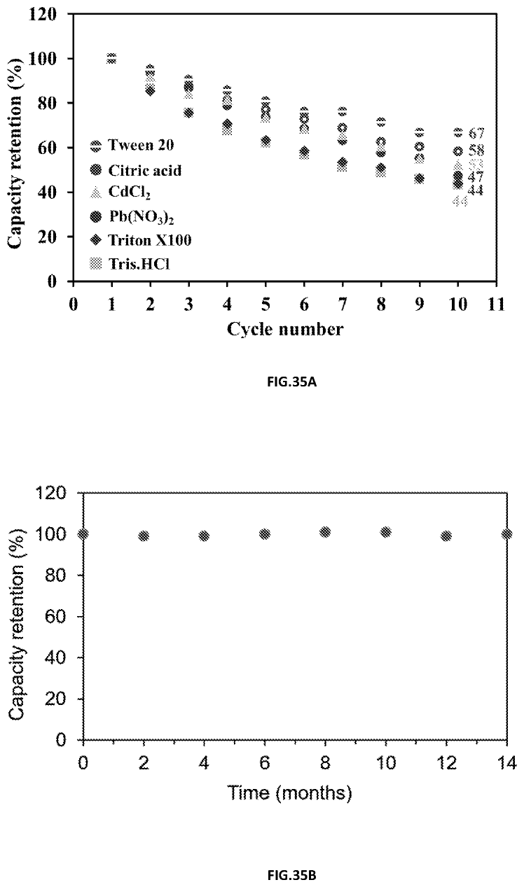

FIG. 35A shows a cycling stability graph of exemplary Zn∥Ni energy storage devices with different additives. As shown, in some embodiments, the addition of the chemical suppressors further diminished the capacity of the device. This reduced capacity may be attributed to the additives, especially those that are organic, occupying the metal active sites. As such, in some embodiments, the adapted pulse-driven regenerative approach is more effective than the previously reported remedies for improving the long-term stability of Zn-based batteries.

FIG. 35B shows a capacity retention graph of an exemplary Zn∥Ni energy storage device. As shown, the performance of the exemplary device maintains is stability over a period of time of about 14 months. In some embodiments, the architecture formed by the interconnected pores in the graphene scaffold enables the rapid transport of electrons and ions, accommodates volume changes during redox reactions, and prevents pulverization of the electrode active materials during cycling. The excellent shelf life and long-term stability of the device herein enable its use in an array of energy storage applications.

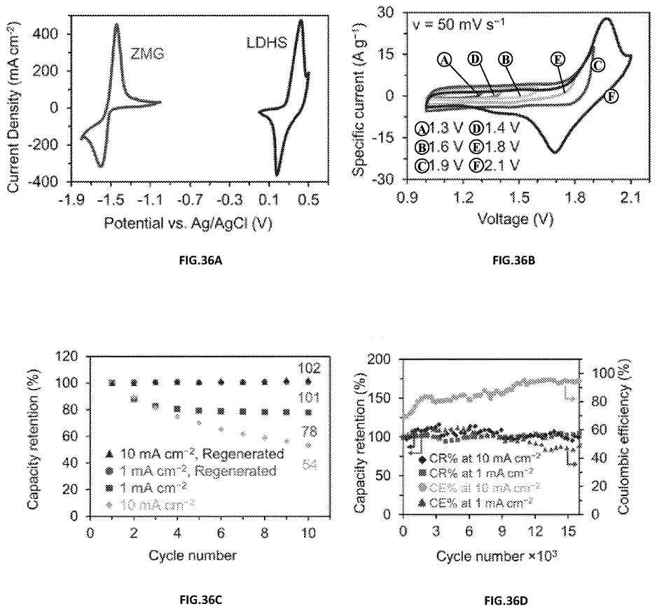

FIG. 36A shows CV curves of an exemplary mass-balanced ZMG electrode and an exemplary LDHS electrode at a scan rate of 50 mV/s in a ZnO saturated 6.0 M KOH electrolyte in a 3E cell system. As shown, the potential windows for the exemplary ZMG electrode and the exemplary LDHS electrode ranges from about −1.8 V to about −1.0 V and about 0 V to about 0.45 V, respectively. The energy storage performance of the exemplary ZMG and the LDHS electrodes suggest that both electrodes can be employed to form a full-cell energy storage device with superior performance.

FIG. 36B shows CV curves of an exemplary Zn∥Ni energy storage device at voltage windows of 1.3V to 2.1V. As shown, an operating voltage window of about 1.1 V is enabled by both capacitive and battery-like energy storage processes.

FIG. 36C shows a cycling stability graph of an exemplary Zn∥Ni energy storage devices that have and have not received a regenerative pulse, and at current densities of 1 mA/cm² and 10 mA/cm². As shown, without the application of regenerative pulses, the device retains about 78% and about 54% of the initial capacity at current densities of 1.0 and 10.0 mA cm⁻², respectively. However, the application of regenerative pulses enables the retention of about 101% and about 102% of the initial capacity at current densities of 1.0 and 10.0 mA cm⁻², respectively. In some embodiments, structural reorganization of the active materials during cycling enables the improved capacity retention. In some embodiments, pore opening and the improved accessibility of electrolyte ions into the pores enables the improved capacity retention. In some embodiments, the improved capacity retention is enabled by kinetic activation of the electrode.

FIG. 36D shows a cycling stability graph of an exemplary Zn∥Ni energy storage device at capacity retention and coulombic efficiencies of 1 mA/cm² and 10 mA/cm² with and without the application of regenerative pulses. As shown, the regenerative pulses enable an extended lifespan of at least about 16,000 GCD cycles. The super-long cycle stability of excellent performance enables maintenance-free large-scale energy storage applications. As shown, the exemplary Zn∥Ni device retains about 100% of its initial capacity with 49% coulombic efficiency after about 16,000 cycles at a current density of about 1.0 mA/cm². Further as shown, the exemplary device retains 100% of its initial capacity with about 95% coulombic efficiency after 16,000 cycles at a high current density of about 10 mA/cm².

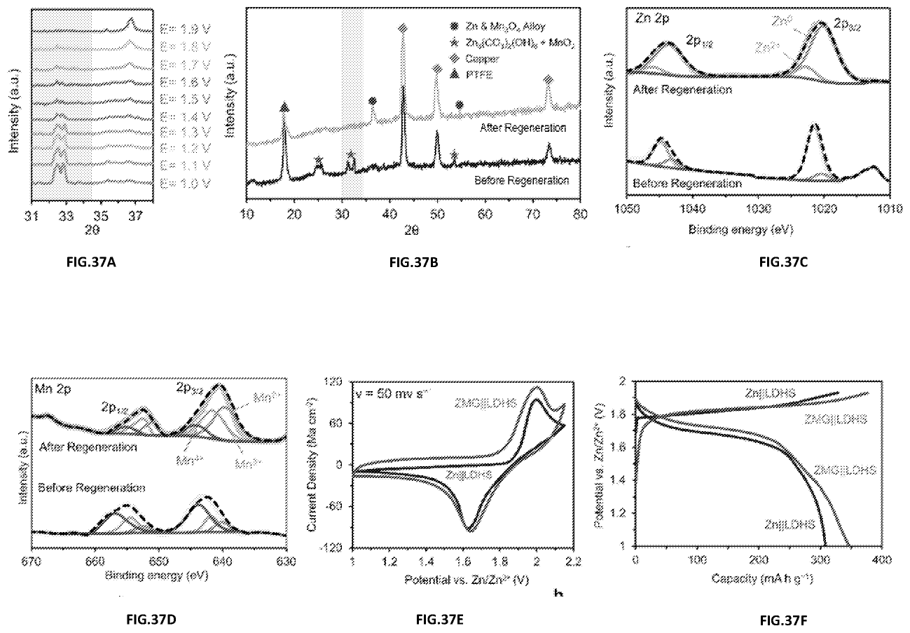

FIG. 37A shows an operando XRD pattern of an exemplary ZMG electrode during the first charge cycle after a regenerative pulse is applied. In some embodiments, faradaic non-capacitive charge storage processes lead to structural transformation accompanied by phase transitions and charging rate reduction. Such structural changes often reduce the performance of energy storage devices. As shown, the reversible phase transformation of the exemplary ZMG is negligible as, during the charging process, the Zn—Mn bimetallic carbonate-oxide turns into Zn metal and Mn species with a low oxidation state.

FIG. 37B shows an operando XRD patterns of an exemplary ZMG electrode before and after a regenerative pulse is applied. As shown, the small pulse steps regenerate the metallic Zn as well as the Mn304 on the surface of the anode.

### Zn-LDHS and ZMG-LDHS Energy Storage Devices

Provided herein is an energy storage device comprising an anode a cathode, and an electrolyte. In some embodiments, the anode comprises bimetallic Zn₍ₓ₎M₍₁₋ₓ₎CO₍₃₎ nanoparticles on a graphene scaffold, wherein M is iron, cobalt, aluminum, manganese, or any combination thereof, and wherein x is less than 1. In some embodiments, the cathode comprises sulfidated Ni—Co—Fe layered double hydroxide nanoparticles. In some embodiments, the layered double hydroxide nanoparticles comprise nanotubes, nanorods, nanoflowers, nanosheets, or any combination thereof. In some embodiments, the energy storage device further comprises a separator between the anode and the cathode.

In some embodiments, the anode comprises bimetallic Zn₍ₓ₎M₍₁₋ₓ₎CO₍₃₎ nanoparticles on a graphene scaffold, wherein x is about 0.01 to about 0.99. nanoparticles on a graphene scaffold, wherein x is about 0.01 to about 0.05, about 0.01 to about 0.1, about 0.01 to about 0.2, about 0.01 to about 0.3, about 0.01 to about 0.4, about 0.01 to about 0.5, about 0.01 to about 0.6, about 0.01 to about 0.7, about 0.01 to about 0.8, about 0.01 to about 0.9, about 0.01 to about 0.99, about 0.05 to about 0.1, about 0.05 to about 0.2, about 0.05 to about 0.3, about 0.05 to about 0.4, about 0.05 to about 0.5, about 0.05 to about 0.6, about 0.05 to about 0.7, about 0.05 to about 0.8, about 0.05 to about 0.9, about 0.05 to about 0.99, about 0.1 to about 0.2, about 0.1 to about 0.3, about 0.1 to about 0.4, about 0.1 to about 0.5, about 0.1 to about 0.6, about 0.1 to about 0.7, about 0.1 to about 0.8, about 0.1 to about 0.9, about 0.1 to about 0.99, about 0.2 to about 0.3, about 0.2 to about 0.4, about 0.2 to about 0.5, about 0.2 to about 0.6, about 0.2 to about 0.7, about 0.2 to about 0.8, about 0.2 to about 0.9, about 0.2 to about 0.99, about 0.3 to about 0.4, about 0.3 to about 0.5, about 0.3 to about 0.6, about 0.3 to about 0.7, about 0.3 to about 0.8, about 0.3 to about 0.9, about 0.3 to about 0.99, about 0.4 to about 0.5, about 0.4 to about 0.6, about 0.4 to about 0.7, about 0.4 to about 0.8, about 0.4 to about 0.9, about 0.4 to about 0.99, about 0.5 to about 0.6, about 0.5 to about 0.7, about 0.5 to about 0.8, about 0.5 to about 0.9, about 0.5 to about 0.99, about 0.6 to about 0.7, about 0.6 to about 0.8, about 0.6 to about 0.9, about 0.6 to about 0.99, about 0.7 to about 0.8, about 0.7 to about 0.9, about 0.7 to about 0.99, about 0.8 to about 0.9, about 0.8 to about 0.99, or about 0.9 to about 0.99, including increments therein. nanoparticles on a graphene scaffold, wherein x is about 0.01, about 0.05, about 0.1, about 0.2, about 0.3, about 0.4, about 0.5, about 0.6, about 0.7, about 0.8, about 0.9, or about 0.99. In some embodiments, the anode comprises bimetallic Zn₍ₓ₎M₍₁₋ₓ₎CO₍₃₎ nanoparticles on a graphene scaffold, wherein x is at most about 0.05, about 0.1, about 0.2, about 0.3, about 0.4, about 0.5, about 0.6, about 0.7, about 0.8, about 0.9, or about 0.99.

In some embodiments, a molar ratio of Zn to M in the energy storage device is about 1:1 to about 7:1. In some embodiments, a molar ratio of Zn to M in the energy storage device is about 1:1 to about 2:1, about 1:1 to about 3:1, about 1:1 to about 4:1, about 1:1 to about 5:1, about 1:1 to about 6:1, about 1:1 to about 7:1, about 2:1 to about 3:1, about 2:1 to about 4:1, about 2:1 to about 5:1, about 2:1 to about 6:1, about 2:1 to about 7:1, about 3:1 to about 4:1, about 3:1 to about 5:1, about 3:1 to about 6:1, about 3:1 to about 7:1, about 4:1 to about 5:1, about 4:1 to about 6:1, about 4:1 to about 7:1, about 5:1 to about 6:1, about 5:1 to about 7:1, or about 6:1 to about 7:1, including increments therein. In some embodiments, a molar ratio of Zn to M in the energy storage device is about 1:1, about 2:1, about 3:1, about 4:1, about 5:1, about 6:1, or about 7:1. In some embodiments, a molar ratio of Zn to M in the energy storage device is at least about 1:1, about 2:1, about 3:1, about 4:1, about 5:1, or about 6:1. In some embodiments, a molar ratio of Zn to M in the energy storage device is at most about 2:1, about 3:1, about 4:1, about 5:1, about 6:1, or about 7:1.

In some embodiments, the electrolytes herein prevent zinc from leaching out of the anode for improved capacity retention after multiple cycles of charging and discharging. In some embodiments, the electrolytes herein prevent hydrogen evolution. In some embodiments, the electrolyte is alkaline. In some embodiments, the alkaline electrolyte reduces zinc leaching from the electrodes. In some embodiments, the electrolyte comprises a hydroxide and a stabilizer.

In some embodiments, the hydroxide comprises aluminum hydroxide, barium hydroxide, benzyltrimethylammonium hydroxide, beryllium hydroxide, cadmium hydroxide, cesium hydroxide, calcium hydroxide, cerium(III) hydroxide, chromium acetate hydroxide, chromium(III) hydroxide, cobalt(II) hydroxide, cobalt(III) hydroxide, copper(I) hydroxide, copper(II) hydroxide, curium hydroxide, gallium(III) hydroxide, germanium(II) hydroxide, gold(III) hydroxide, indium(III) hydroxide, iron(II) hydroxide, iron(III) oxide-hydroxide, lanthanum hydroxide, lead(II) hydroxide, lead(IV) hydroxide, lithium hydroxide, magnesium hydroxide, manganese(II) hydroxide, mercury(II) hydroxide, metal hydroxide, nickel(II) hydroxide, potassium hydroxide, rubidium hydroxide, sodium hydroxide, strontium hydroxide, tetrabutylammonium hydroxide, tetramethylammonium hydroxide, thallium hydroxide, thallium(I) hydroxide, thallium(III) hydroxide, tin(II) hydroxide, uranyl hydroxide, zinc hydroxide, zirconium(IV) hydroxide, or any combination thereof. In some embodiments, the stabilizer comprises zinc oxide, zinc hydroxide, sodium zincate, potassium zincate, bismuth oxide, cadmium oxide, indium sulfate, lead oxide, a metallic zinc powder, or any combination thereof. In some embodiments, the hydrogen evolution inhibitor comprises bismuth oxide, cadmium oxide, a conductive ceramic, lead oxide, a metallic zinc powder antimony sulfate, gallium hydroxide, indium sulfate, lithium hydroxide, or any combination thereof. In some embodiments, the stabilizer suppresses hydrogen evolution.

In some embodiments, the electrolyte has a concentration of the hydroxide of about 1 M to about 20 M. In some embodiments, the electrolyte has a concentration of the hydroxide of about 1 M to about 2 M, about 1 M to about 3 M, about 1 M to about 6 M, about 1 M to about 9 M, about 1 M to about 12 M, about 1 M to about 15 M, about 1 M to about 18 M, about 1 M to about 20 M, about 2 M to about 3 M, about 2 M to about 6 M, about 2 M to about 9 M, about 2 M to about 12 M, about 2 M to about 15 M, about 2 M to about 18 M, about 2 M to about 20 M, about 3 M to about 6 M, about 3 M to about 9 M, about 3 M to about 12 M, about 3 M to about 15 M, about 3 M to about 18 M, about 3 M to about 20 M, about 6 M to about 9 M, about 6 M to about 12 M, about 6 M to about 15 M, about 6 M to about 18 M, about 6 M to about 20 M, about 9 M to about 12 M, about 9 M to about 15 M, about 9 M to about 18 M, about 9 M to about 20 M, about 12 M to about 15 M, about 12 M to about 18 M, about 12 M to about 20 M, about 15 M to about 18 M, about 15 M to about 20 M, or about 18 M to about 20 M, including increments therein. In some embodiments, the electrolyte has a concentration of the hydroxide of about 1 M, about 2 M, about 3 M, about 6 M, about 9 M, about 12 M, about 15 M, about 18 M, or about 20 M. In some embodiments, the electrolyte has a concentration of the hydroxide of at least about 1 M, about 2 M, about 3 M, about 6 M, about 9 M, about 12 M, about 15 M, or about 18 M. In some embodiments, the electrolyte has a concentration of the hydroxide of at most about 2 M, about 3 M, about 6 M, about 9 M, about 12 M, about 15 M, about 18 M, or about 20 M.

In some embodiments, a concentration by mass of the hydroxide within the electrolyte is about 22% to about 91%. In some embodiments, a concentration by mass of the hydroxide within the electrolyte is about 22% to about 25%, about 22% to about 30%, about 22% to about 35%, about 22% to about 40%, about 22% to about 45%, about 22% to about 50%, about 22% to about 55%, about 22% to about 60%, about 22% to about 70%, about 22% to about 80%, about 22% to about 91%, about 25% to about 30%, about 25% to about 35%, about 25% to about 40%, about 25% to about 45%, about 25% to about 50%, about 25% to about 55%, about 25% to about 60%, about 25% to about 70%, about 25% to about 80%, about 25% to about 91%, about 30% to about 35%, about 30% to about 40%, about 30% to about 45%, about 30% to about 50%, about 30% to about 55%, about 30% to about 60%, about 30% to about 70%, about 30% to about 80%, about 30% to about 91%, about 35% to about 40%, about 35% to about 45%, about 35% to about 50%, about 35% to about 55%, about 35% to about 60%, about 35% to about 70%, about 35% to about 80%, about 35% to about 91%, about 40% to about 45%, about 40% to about 50%, about 40% to about 55%, about 40% to about 60%, about 40% to about 70%, about 40% to about 80%, about 40% to about 91%, about 45% to about 50%, about 45% to about 55%, about 45% to about 60%, about 45% to about 70%, about 45% to about 80%, about 45% to about 91%, about 50% to about 55%, about 50% to about 60%, about 50% to about 70%, about 50% to about 80%, about 50% to about 91%, about 55% to about 60%, about 55% to about 70%, about 55% to about 80%, about 55% to about 91%, about 60% to about 70%, about 60% to about 80%, about 60% to about 91%, about 70% to about 80%, about 70% to about 91%, or about 80% to about 91%. In some embodiments, a concentration by mass of the hydroxide within the electrolyte is about 22%, about 25%, about 30%, about 35%, about 40%, about 45%, about 50%, about 55%, about 60%, about 70%, about 80%, or about 91%. In some embodiments, a concentration by mass of the hydroxide within the electrolyte is at least about 22%, about 25%, about 30%, about 35%, about 40%, about 45%, about 50%, about 55%, about 60%, about 70%, or about 80%. In some embodiments, a concentration by mass of the hydroxide within the electrolyte is at most about 25%, about 30%, about 35%, about 40%, about 45%, about 50%, about 55%, about 60%, about 70%, about 80%, or about 91%.

In some embodiments, a concentration by volume of the hydroxide within the electrolyte is about 220 g/L to about 900 g/L. In some embodiments, a concentration by volume of the hydroxide within the electrolyte is about 220 g/L to about 250 g/L, about 220 g/L to about 300 g/L, about 220 g/L to about 350 g/L, about 220 g/L to about 400 g/L, about 220 g/L to about 450 g/L, about 220 g/L to about 500 g/L, about 220 g/L to about 550 g/L, about 220 g/L to about 600 g/L, about 220 g/L to about 700 g/L, about 220 g/L to about 800 g/L, about 220 g/L to about 900 g/L, about 250 g/L to about 300 g/L, about 250 g/L to about 350 g/L, about 250 g/L to about 400 g/L, about 250 g/L to about 450 g/L, about 250 g/L to about 500 g/L, about 250 g/L to about 550 g/L, about 250 g/L to about 600 g/L, about 250 g/L to about 700 g/L, about 250 g/L to about 800 g/L, about 250 g/L to about 900 g/L, about 300 g/L to about 350 g/L, about 300 g/L to about 400 g/L, about 300 g/L to about 450 g/L, about 300 g/L to about 500 g/L, about 300 g/L to about 550 g/L, about 300 g/L to about 600 g/L, about 300 g/L to about 700 g/L, about 300 g/L to about 800 g/L, about 300 g/L to about 900 g/L, about 350 g/L to about 400 g/L, about 350 g/L to about 450 g/L, about 350 g/L to about 500 g/L, about 350 g/L to about 550 g/L, about 350 g/L to about 600 g/L, about 350 g/L to about 700 g/L, about 350 g/L to about 800 g/L, about 350 g/L to about 900 g/L, about 400 g/L to about 450 g/L, about 400 g/L to about 500 g/L, about 400 g/L to about 550 g/L, about 400 g/L to about 600 g/L, about 400 g/L to about 700 g/L, about 400 g/L to about 800 g/L, about 400 g/L to about 900 g/L, about 450 g/L to about 500 g/L, about 450 g/L to about 550 g/L, about 450 g/L to about 600 g/L, about 450 g/L to about 700 g/L, about 450 g/L to about 800 g/L, about 450 g/L to about 900 g/L, about 500 g/L to about 550 g/L, about 500 g/L to about 600 g/L, about 500 g/L to about 700 g/L, about 500 g/L to about 800 g/L, about 500 g/L to about 900 g/L, about 550 g/L to about 600 g/L, about 550 g/L to about 700 g/L, about 550 g/L to about 800 g/L, about 550 g/L to about 900 g/L, about 600 g/L to about 700 g/L, about 600 g/L to about 800 g/L, about 600 g/L to about 900 g/L, about 700 g/L to about 800 g/L, about 700 g/L to about 900 g/L, or about 800 g/L to about 900 g/L. In some embodiments, a concentration by volume of the hydroxide within the electrolyte is about 220 g/L, about 250 g/L, about 300 g/L, about 350 g/L, about 400 g/L, about 450 g/L, about 500 g/L, about 550 g/L, about 600 g/L, about 700 g/L, about 800 g/L, or about 900 g/L. In some embodiments, a concentration by volume of the hydroxide within the electrolyte is at least about 220 g/L, about 250 g/L, about 300 g/L, about 350 g/L, about 400 g/L, about 450 g/L, about 500 g/L, about 550 g/L, about 600 g/L, about 700 g/L, or about 800 g/L. In some embodiments, a concentration by volume of the hydroxide within the electrolyte is at most about 250 g/L, about 300 g/L, about 350 g/L, about 400 g/L, about 450 g/L, about 500 g/L, about 550 g/L, about 600 g/L, about 700 g/L, about 800 g/L, or about 900 g/L.

In some embodiments, a concentration by mass of the conductivity enhancer within the electrolyte is about 1% to about 5%. In some embodiments, a concentration by mass of the conductivity enhancer within the electrolyte is about 1% to about 1.5%, about 1% to about 2%, about 1% to about 2.5%, about 1% to about 3%, about 1% to about 3.5%, about 1% to about 4%, about 1% to about 4.5%, about 1% to about 5%, about 1.5% to about 2%, about 1.5% to about 2.5%, about 1.5% to about 3%, about 1.5% to about 3.5%, about 1.5% to about 4%, about 1.5% to about 4.5%, about 1.5% to about 5%, about 2% to about 2.5%, about 2% to about 3%, about 2% to about 3.5%, about 2% to about 4%, about 2% to about 4.5%, about 2% to about 5%, about 2.5% to about 3%, about 2.5% to about 3.5%, about 2.5% to about 4%, about 2.5% to about 4.5%, about 2.5% to about 5%, about 3% to about 3.5%, about 3% to about 4%, about 3% to about 4.5%, about 3% to about 5%, about 3.5% to about 4%, about 3.5% to about 4.5%, about 3.5% to about 5%, about 4% to about 4.5%, about 4% to about 5%, or about 4.5% to about 5%. In some embodiments, a concentration by mass of the conductivity enhancer within the electrolyte is about 1%, about 1.5%, about 2%, about 2.5%, about 3%, about 3.5%, about 4%, about 4.5%, or about 5%. In some embodiments, a concentration by mass of the conductivity enhancer within the electrolyte is at least about 1%, about 1.5%, about 2%, about 2.5%, about 3%, about 3.5%, about 4%, or about 4.5%. In some embodiments, a concentration by mass of the conductivity enhancer within the electrolyte is at most about 1.5%, about 2%, about 2.5%, about 3%, about 3.5%, about 4%, about 4.5%, or about 5%.

In some embodiments, the electrolyte further comprises a conductivity enhancer comprising a conductive ceramic. In some embodiments, the conductive ceramic comprises lead zirconate titanate (PZT), barium titanate(BT), strontium titanate (ST), calcium titanate (CT), magnesium titanate (MT), calcium magnesium titanate (CMT), zinc titanate (ZT), lanthanum titanate (LT), and neodymium titanate (NT), barium zirconate (BZ), calcium zirconate (CZ), lead magnesium niobate (PMN), lead zinc niobate (PZN), lithium niobate (LN), barium stannate (BS), calcium stannate (CS), magnesium aluminum silicate, magnesium silicate, barium tantalate, titanium dioxide, niobium oxide, zirconia, quartz, silica, sapphire, beryllium oxide, zirconium tin titanate, indium tin oxide (ITO), lanthanum-doped strontium titanate (SLT), yttrium-doped strontium titanate (SYT), yttria-stabilized zirconia (YSZ), gadolinium-doped ceria (GDC), lanthanum strontium gallate magnesite (LSGM), or any combination thereof.

In some embodiments, electrolyte further comprises: an additive comprising calcium hydroxide, calcium titanate, calcium zincate, potassium fluoride, sodium phosphate tribasic, potassium phosphate, sodium fluoride, potassium borate, potassium carbonate, or any combination thereof; a hydrogen evolution inhibitor comprising bismuth oxide, cadmium oxide, a conductive ceramic, lead oxide, a metallic zinc powder antimony sulfate, gallium hydroxide, indium sulfate, lithium hydroxide, or any combination thereof; or both.

FIG. 37C shows a Zn 2p XPS spectra of an exemplary Zn∥LDHS energy storage device and an exemplary ZMG∥LDHS energy storage device. FIG. 37D shows a Mn 2p XPS spectra of an exemplary Zn∥LDHS energy storage device and an exemplary ZMG∥LDHS energy storage device before and after applying regenerative pulses. As shown, a shift of about 0.8 eV for Zn 2p and about 2.8 eV for Mn 2p bands after applying potential pulses indicates that Zn²⁺ transforms to Zn⁰ and Mn⁴⁺ reduces to Mn³⁺ and Mn²⁺.

FIGS. 37E and 37F show CV and GCD curves of an exemplary Zn∥LDHS energy storage device and an exemplary ZMG∥LDHS energy storage device. As shown, the ZMG electrode demonstrates an improved capacitive performance, a higher reversibility, and a smaller potential hysteresis between charge and discharge plateaus than a commercial zinc foil anode.

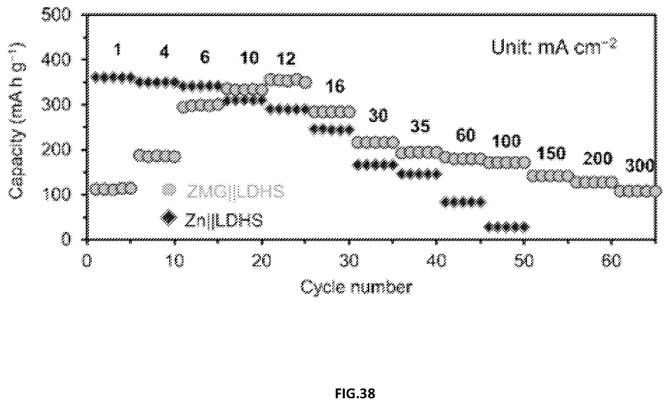

FIG. 38 shows a rate capability graph of an exemplary Zn∥LDHS energy storage device and an exemplary ZMG∥LDHS energy storage device ta fixed charging rate of about 10 mA/cm² (2.5 A/g) at discharging rates from 1 to 300 mA/cm² within a voltage window of 1-1.9 V. As shown, the discharge capacity of the exemplary ZMG∥LDHS device increases linearly with discharge rate until the discharge rate reaches about 12 mA/cm², wherein the discharge rate increases to about 116 mAh/g at 1 mA/cm² and further increases to about 356 mAh/g at 12 mA/cm², which can be attributed to the suppression of the hydrogen evolution reaction shown below, as attained by the enhanced discharging efficiency of the zinc electrode.

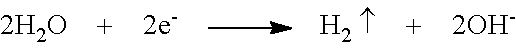

Further increasing the discharge rate gradually decreases the capacity to about 100 mAh/g at 300 mA/cm². In some embodiments, at large overpotentials (i.e. a totally irreversible reaction and a saddle point where the reverse reaction and mass transport effects are absent), the Butler-Volmer equation can be simplified to the Tafel equation below which shows a linear relationship between the hydrogen evolution overpotential (η_{H}_{₂}) and log j (j=current density), with a slope (b) termed the Tafel slope:

$${η}_{{H}_{2}} = \frac{- 2.3 R T}{α n F} log {j}_{0} + \frac{23 R T}{α n F} log j = a + b log j$$

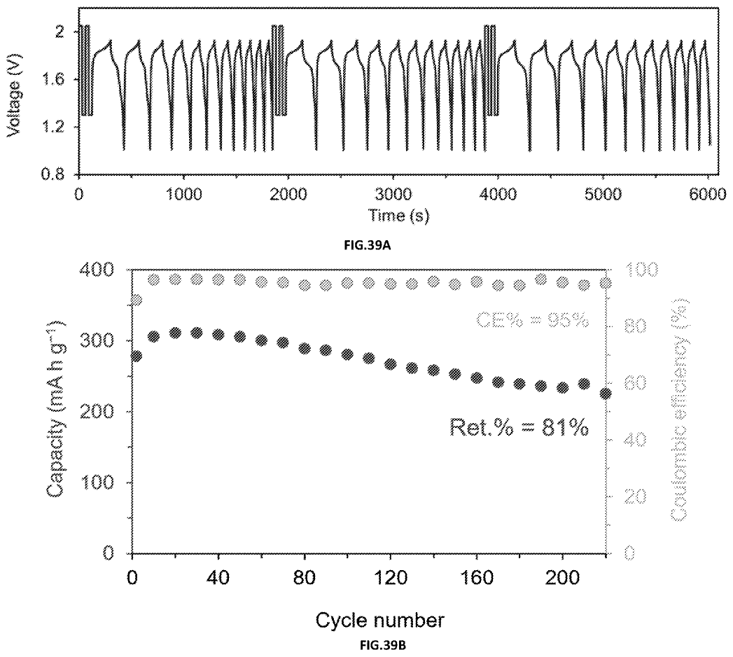

Thus, in some embodiments, there is a trade-off between increasing current densities and increased discharge efficiency. In some embodiments, the inhibitory effects on the evolution of hydrogen plays a dominant role at discharging rates below about 12 mA/cm², while increasing electrode polarization dominates at discharging rates higher than about 12 mA/cm². In some embodiments, best device performance (e.g., 360 mAh/g at 1 mA/cm²) is achieved at a current regime of up to about 6 mA/cm². FIG. 39A shows a pulse-driven regeneration graph of an exemplary Zn∥Ni energy storage device. Many current Zn-based energy storage devices suffer from parasitic hydrogen evolution, Zn dendrite formation, and active materials dissolution. Further, the exposure of the metallic zinc to the aqueous electrolytes in many such current devices catalyze the HER process that causes further. As such, in some embodiments, a pulse technique is employed to restore the full performance and capacity of the Zn∥Ni battery. In some embodiments, as shown, a first voltage step is applied at about 2 V for a period of time of about 30 seconds, and a second voltage step is applied at about 1.30 V for a period of time of about 30 seconds. In some embodiments, as shown, the first voltage step and the second voltage step are applied after a round of about 10 GCD cycles.

In some embodiments, a method of applying regenerative voltage pulse to an energy storage device comprising: after a sequence of galvanostatic charge-discharge (GCD) cycles: applying a first voltage pulse at a first voltage for a first period of time; applying a second voltage pulse at a second voltage for a second period of time. In some embodiments, the first voltage is about 1.5 V to about 2.5 V. In some embodiments, the first voltage is at least about 1.5 V, 1.75 V, 2 V, or 2.25 V. In some embodiments, the first voltage is at most about 1.75 V, 2 V, 2.25 V, or 2.5 V. In some embodiments, the second voltage is about 1.5 V to about 2.5 V. In some embodiments, the second voltage is at least about 1.5 V, 1.75 V, 2 V, or 2.25 V. In some embodiments, the second voltage is at most about 1.75 V, 2 V, 2.25 V, or 2.5 V. In some embodiments, the first period of time, the second period of time, or both is about 15 seconds to about 30 seconds. In some embodiments, the first period of time, the second period of time, or both is at least about 15 seconds, 20 seconds, or 25 seconds. In some embodiments, the first period of time, the second period of time, or both is at most about 20 seconds, 25 seconds, or about 30 seconds. In some embodiments, the sequence of GCD cycles comprises about 8 GCD cycles to about 14 GCD cycles. In some embodiments, the sequence of GCD cycles comprises 8, 9, 10, 11, 12, 13, or 14 GCD cycles.

FIG. 39B shows a cycling stability graph of an energy storage device with a zinc foil anode, at the charge-discharge rate of 10.0 mA cm⁻. As shown, the energy storage device with a zinc foil anode retains only 81% of its initial capacity after 220 cycle with a 95% coulombic efficiency, implying that compositing of the metal species with the graphene scaffold energy devices described herein significantly enhances the energy storage performance.

In some embodiments, a mass loading ratio of the electroactive materials in the anode and the cathode is balanced such that the electric charges stored therein are equal. In some embodiments, to enable equal charge storage between the anode and cathode, the mass ratio of LDHS to the ZMG nanocomposite is about 1:3. In some embodiments, a mass ratio between the electroactive materials in the anode and the cathode is about 1:1 to about 7:1. In some embodiments, a mass ratio between the electroactive materials in the anode and the cathode is about 1:1 to about 2:1, about 1:1 to about 3:1, about 1:1 to about 4:1, about 1:1 to about 5:1, about 1:1 to about 6:1, about 1:1 to about 7:1, about 2:1 to about 3:1, about 2:1 to about 4:1, about 2:1 to about 5:1, about 2:1 to about 6:1, about 2:1 to about 7:1, about 3:1 to about 4:1, about 3:1 to about 5:1, about 3:1 to about 6:1, about 3:1 to about 7:1, about 4:1 to about 5:1, about 4:1 to about 6:1, about 4:1 to about 7:1, about 5:1 to about 6:1, about 5:1 to about 7:1, or about 6:1 to about 7:1, including increments therein. In some embodiments, a mass ratio between the electroactive materials in the anode and the cathode is about 1:1, about 2:1, about 3:1, about 4:1, about 5:1, about 6:1, or about 7:1. In some embodiments, a mass ratio between the electroactive materials in the anode and the cathode is at least about 1:1, about 2:1, about 3:1, about 4:1, about 5:1, or about 6:1. In some embodiments, a mass ratio between the electroactive materials in the anode and the cathode is at most about 2:1, about 3:1, about 4:1, about 5:1, about 6:1, or about 7:1.

In some embodiments, the energy storage device has a rate capability of at least about 200 mAh/g, 225 mAh/g, 250 mAh/g, 275 mAh/g, 300 mAh/g, 325 mAh/g, 350 mAh/g, 375 mAh/g, or 400 mAh/g at 12 A/g. In some embodiments, the energy storage device has a rate capability of at least about 80 mAh/g, 85 mAh/g, 90 mAh/g, 95 mAh/g, 100 mAh/g, 105 mAh/g, 110 mAh/g, 115 mAh/g, 120 mAh/g, 125 mAh/g, or 130 mAh/g at 300 A/g.

In some embodiments, the energy storage device has a capacity retention of at least about 90%, 95%, 96%, 97%, 98%, or 99% after about 16,000 cycles at about 100% depth of discharge. In some embodiments, the energy storage device has a time constant of less than about 0.5 seconds, 0.45 seconds, 0.4 seconds, 0.35 seconds, 0.3 seconds, 0.25 seconds, 0.2 seconds, or 0.1 seconds.

Specific energy and specific power are two of the main criteria used to characterize energy storage devices. In some embodiments, specific energy is determined based on the mass of the cathode active material. In some embodiments, the energy storage device has a specific energy at a specific power of about 19 kW/kg of at least about 500 Wh/kg, 525 Wh/kg, 550 Wh/kg, 575 Wh/kg, 600 Wh/kg, or 625 Wh/kg. In some embodiments, the energy storage device has a specific energy at a specific power of about 430 kW/kg of at least about 100 Wh/kg, 125 Wh/kg, 150 Wh/kg, 175 Wh/kg, 200 Wh/kg, 225 Wh/kg, or 250 Wh/kg. In some embodiments, the energy storage device has a specific power of at least about 10 Wh/kg, 20 Wh/kg, 50 Wh/kg, 75 Wh/kg, 100 Wh/kg, 150 Wh/kg, 200 Wh/kg, 250 Wh/kg, 300 Wh/kg, 350 Wh/kg, 400 Wh/kg, 450 Wh/kg, 500 Wh/kg, 550 Wh/kg, 600 Wh/kg, 650 Wh/kg, 700 Wh/kg, or 750 Wh/kg.

The electrodes described herein comprising bimetallic ZnₓM₁₋ₓCO₃ and a graphene scaffold as a negative electrode solve a number of problems with prior art zinc based electrodes which prevent the widespread adoption of zinc based batteries. Such electrodes may produce an electrode structure comprising smooth surfaces of a few well-separated layers of graphene sheets coated by deposited bimetal carbonate microparticles that form 3D interconnected porous a graphene scaffold networks surrounding the bimetallic carbonate nanoparticles that serve as electron transfer highways while providing void spaces for the volume expansion of the metallic species. Such bimetallic ZnₓM₁₋ₓCO₃ and a graphene scaffold based electrodes represent a significant improvement over prior art zinc based electrodes which lack such properties among the conversion type electrode active materials. The Mn and Zn elements may be rather uniformly distributed within a single-phase crystal, instead of two separate phases, which may show the atomic-scale distribution of the constituent elements (Zn and Mn) in the bimetallic carbonate. Benefitting from the structural merits of the substantially improved electrical conductivity and atomic-scale synergistic effects of the constituent elements, such nanocomposite anodes can deliver outstanding capacities of 343 mA h g⁻¹ at 1.0 A g⁻¹. Such improved negative electrodes solve issues preventing the widespread adoption of zinc nickel batteries by improving the columbic efficiency of the negative electrode, and by preventing dendritic growth at the negative electrode that is typical of prior art zinc based electrode compositions.

The electrodes described herein comprising positive sulfidated Ni—Co—Fe layered double hydroxide nanoparticles solve a number of problems with prior art zinc based electrodes which prevent the widespread adoption of zinc based batteries. Such electrodes may produce an electrode structure comprising LDH nanoparticles, such as nanowalls, which transformed into nanotubes that provide a large accessible surface area, a better electrical conductivity, along with a facilitated ion transport pathway in the material. Benefitting from the structural merits of the substantially improved electrical conductivity and atomic-scale synergistic effects of the constituent elements, the binder-free LDHS cathode can deliver an outstanding capacity of and 638 mA h g⁻¹ at 1.0 A g⁻¹. Such improved positive electrodes solve issues preventing the widespread adoption of zinc nickel batteries by improving the fast fading capacity typical of conventional nickel based electrodes.

The energy storage devices described herein comprising an anode with bimetallic ZnₓM₁₋ₓCO₃ and a graphene scaffold, and a cathode with sulfidated Ni—Co—Fe layered double hydroxide nanoparticles, benefits from the substantially improved electrical conductivity and atomic-scale synergistic effects of the novel anode and cathode materials disclosed herein. Such improved energy storage devices solve issues preventing the widespread adoption of zinc nickel batteries by delivering batteries comprising excellent capacity, superb rate capability, extremely high specific energy, an outstanding specific power, along with a high output voltage in energy storage devices that can maintain such energy storage and transfer characteristics for thousands of cycles over the life of the device due to the unprecedented cycling stability, possibly resulting from the electrochemical pulse-driven regenerative mechanism.

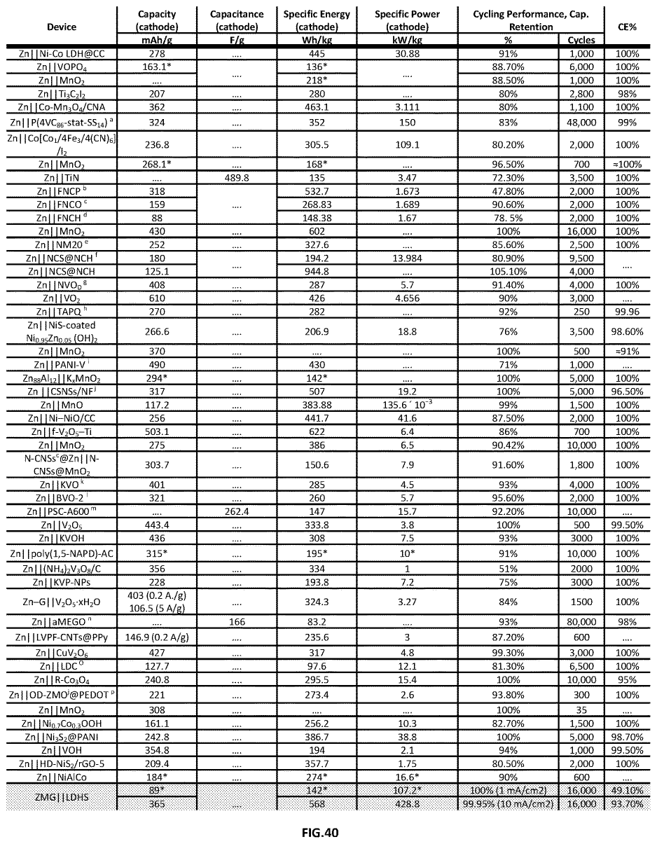

FIG. 40 shows a chart comparing the performance of current energy storage devices with the disclosed energy storage devices. In an exemplary embodiment, the energy storage device herein (bottom row) comprising a Zn∥Ni alkaline (6.0 M KOH) battery, exhibits a high rate capability (356 mA h g⁻¹_{cathode} at 12 A g⁻¹; 108 mA h g⁻¹_{cathode} at 300 A g⁻¹), a very large specific energy (568 W h kg⁻¹_{cathode}), a very high specific power (429 kW kg⁻¹_{cathode}), a high output voltage (1.8 V), with unprecedented cycling stability (~100% capacity retention after 16,000 cycles at 100% depth of discharge). Such improved energy storage devices may permit the widespread application of aqueous Zn-based batteries in electric vehicles and stationary grid/off-grid storage applications.

| | | | Specific | Specific | Cycling | | |
|---|---|---|---|---|---|---|---|
| | Capacity | Capacitance | Energy | Power | Performance, Cap. | | |
| | (cathode) | (cathode) | (cathode) | (cathode) | Retention | | |
| Device | mAh/g | F/g | Wh/kg | kW/kg | % | Cycles | CE % |
| Zn \| \| Ni—Co LDH@CC | 278 | . . . | 445 | 30.88 | 91% | 1,000 | 100% |
| Zn \| \| VOPO₄ | 163.1* | . . . | 136* | . . . | 88.70% | 6,000 | 100% |
| Zn \| \| MnO₂ | . . . | | 218* | | 88.50% | 1,000 | 100% |
| Zn \| \| Ti₃C₂I₂ | 207 | . . . | 280 | . . . | 80% | 2,800 | 98% |
| Zn \| \| Co—Mn₃O₄/CNA | 362 | . . . | 463.1 | 3.111 | 80% | 1,100 | 100% |
| Zn \| \| P(4VC₈₆-stat-SS₁₄) ^{a} | 324 | . . . | 352 | 150 | 83% | 48,000 | 99% |
| Zn \| \| Co[Co₁/4Fe₃/4(CN)₆]/I₂ | 236.8 | . . . | 305.5 | 109.1 | 80.20% | 2,000 | 100% |
| Zn \| \| MnO₂ | 268.1* | . . . | 168* | . . . | 96.50% | 700 | ≈100% |
| Zn \| \| TIN | . . . | 489.8 | 135 | 3.47 | 72.30% | 3,500 | 100% |
| Zn \| \| FNCP ^{b} | 318 | . . . | 532.7 | 1.673 | 47.80% | 2,000 | 100% |
| Zn \| \| FNCO ^{c} | 159 | | 268.83 | 1.689 | 90.60% | 2,000 | 100% |
| Zn \| \| FNCH ^{d} | 88 | | 148.38 | 1.67 | 78.5% | 2,000 | 100% |
| Zn \| \| MnO₂ | 430 | . . . | 602 | . . . | 100% | 16,000 | 100% |
| Zn \| \| NM20 ^{e} | 252 | . . . | 327.6 | . . . | 85.60% | 2,500 | 100% |
| Zn \| \| NCS@NCH ^{f} | 180 | . . . | 194.2 | 13.984 | 80.90% | 9,500 | . . . |
| Zn \| \| NCS@NCH | 125.1 | | 944.8 | . . . | 105.10% | 4,000 | |
| Zn \| \| NVO_{D} ^{g} | 408 | . . . | 287 | 5.7 | 91.40% | 4,000 | 100% |
| Zn \| \| VO₂ | 610 | . . . | 426 | 4.656 | 90% | 3,000 | . . . |
| Zn \| \| TAPQ ^{h} | 270 | . . . | 282 | . . . | 92% | 250 | 99.96 |
| Zn \| \| NiS-coated Ni_{0.95}Zn_{0.05}(OH)₂ | 266.6 | . . . | 206.9 | 18.8 | 76% | 3,500 | 98.60% |
| Zn \| \| MnO₂ | 370 | . . . | . . . | . . . | 100% | 500 | ≈91% |
| Zn \| \| PANI-V ⁱ | 490 | . . . | 430 | . . . | 71% | 1,000 | . . . |
| Zn₈₈Al₁₂ \| \| KₓMnO₂ | 294* | . . . | 142* | . . . | 100% | 5,000 | 100% |
| Zn \| \| CSNSs/NF^{j} | 317 | . . . | 507 | 19.2 | 100% | 5,000 | 96.50% |
| Zn \| \| MnO | 117.2 | . . . | 383.88 | 135.6 \acute{ } 10⁻³ | 99% | 1,500 | 100% |
| Zn \| \| Ni—NiO/CC | 256 | . . . | 441.7 | 41.6 | 87.50% | 2,000 | 100% |
| Zn \| \| f-V₂O₅—Ti | 503.1 | . . . | 622 | 6.4 | 86% | 700 | 100% |
| Zn \| \| MnO₂ | 275 | . . . | 386 | 6.5 | 90.42% | 10,000 | 100% |
| N-CNSs^{c}@Zn \| \| N-CNSs@MnO₂ | 303.7 | . . . | 150.6 | 7.9 | 91.60% | 1,800 | 100% |
| Zn \| \| KVO ^{k} | 401 | . . . | 285 | 4.5 | 93% | 4,000 | 100% |
| Zn \| \| BVO-2 ^{l} | 321 | . . . | 260 | 5.7 | 95.60% | 2,000 | 100% |
| Zn \| \| PSC-A600 ^{m} | . . . | 262.4 | 147 | 15.7 | 92.20% | 10,000 | . . . |
| Zn \| \| V₂O₅ | 443.4 | . . . | 333.8 | 3.8 | 100% | 500 | 99.50% |
| Zn \| \| KVOH | 436 | . . . | 308 | 7.5 | 93% | 3000 | 100% |
| Zn \| \| poly(1,5-NAPD)-AC | 315* | . . . | 195* | 10* | 91% | 10,000 | 100% |
| Zn \| \| (NH₄)₂V₃O₈/C | 356 | . . . | 334 | 1 | 51% | 2000 | 100% |
| Zn \| \| KVP-NPs | 228 | . . . | 193.8 | 7.2 | 75% | 3000 | 100% |
| Zn—G \| \| V₂O₅•xH₂O | 403 | . . . | 324.3 | 3.27 | 84% | 1500 | 100% |
| | (0.2 A./g) | | | | | | |
| | 106.5 | | | | | | |
| | (5 A/g) | | | | | | |
| Zn \| \| aMEGO ⁿ | . . . | 166 | 83.2 | . . . | 93% | 80,000 | 98% |
| Zn \| \| LVPF-CNTs@PPy | 146.9 | . . . | 235.6 | 3 | 87.20% | 600 | . . . |
| | (0.2 A/g) | | | | | | |
| Zn \| \| CuV₂O₆ | 427 | . . . | 317 | 4.8 | 99.30% | 3,000 | 100% |
| Zn \| \| LDC ^{O} | 127.7 | . . . | 97.6 | 12.1 | 81.30% | 6,500 | 100% |
| Zn \| \| R-Co₃O₄ | 240.8 | . . . | 295.5 | 15.4 | 100% | 10,000 | 95% |
| Zn \| \| OD-ZMO^{j}@PEDOT ^{p} | 221 | . . . | 273.4 | 2.6 | 93.80% | 300 | 100% |
| Zn \| \| MnO₂ | 308 | . . . | . . . | . . . | 100% | 35 | . . . |
| Zn \| \| Ni_{0.7}Co_{0.3}OOH | 161.1 | . . . | 256.2 | 10.3 | 82.70% | 1,500 | 100% |
| Zn \| \| Ni₃S₂@PANI | 242.8 | . . . | 386.7 | 38.8 | 100% | 5,000 | 98.70% |
| Zn \| \| VOH | 354.8 | . . . | 194 | 2.1 | 94% | 1,000 | 99.50% |
| Zn \| \| HD-NiS₂/rGO-5 | 209.4 | . . . | 357.7 | 1.75 | 80.50% | 2,000 | 100% |
| Zn \| \| NiAlCo | 184* | . . . | 274* | 16.6* | 90% | 600 | . . . |
| Zn \| \| LDHS | 89* | | 142* | 107.2* | 100% | 16,000 | 49.10% |
| | | | | | (1 mA/cm2) | | |
| | 365 | | 568 | 428.8 | 99.95% | 16,000 | 93.70% |
| | | | | | (10 mA/cm2) | | |

### Terms and Definitions

Unless otherwise defined, all technical terms used herein have the same meaning as commonly understood by one of ordinary skill in the art to which this disclosure belongs.

As used herein, the singular forms “a,” “an,” and “the” ~include plural references unless the context clearly dictates otherwise. Any reference to “or” herein is intended to encompass “and/or” unless otherwise stated.

As used herein, the term “about” in some cases refers to an amount that is approximately the stated amount.

As used herein, the term “about” refers to an amount that is near the stated amount by 10%, 500, or 10%, including increments therein.

As used herein, the term “about” in reference to a percentage refers to an amount that is greater or less the stated percentage by 1000, 500, or 100, including increments therein.

As used herein, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure.

What is claimed is:

1. An energy storage device comprising:
(a) an anode comprising a bimetallic particle on a graphene scaffold, the bimetallic particle comprising ZnₓM₁₋ₓCO₃ nanoparticles, wherein M is iron, cobalt, aluminum, manganese, or any combination thereof, and wherein x is less than 1;
(b) a cathode comprising a layered double hydroxide (LDH) nanotube; and
(c) an electrolyte.

2. The energy storage device of claim 1, wherein layered double hydroxide (LDH) nanotube comprises one or more layered double hydroxide nanoparticles.

3. The energy storage device of claim 1, wherein the bimetallic particle comprises ZnₓM₁₋ₓCO₃ nanoparticles, wherein M is manganese, and wherein x is less than 1.

4. The energy storage device of claim 1, wherein a molar ratio of Zn to M is about 1:1 to about 7:1.

5. The energy storage device of claim 1, wherein the graphene scaffold comprises graphene aerogel, graphene hydrogel, or both.

6. The energy storage device of claim 1, wherein the LDH nanotubes comprise sulfidated Ni—Co—Fe nanotubes.

7. The energy storage device of claim 1, wherein the LDH nanotubes have a diameter of about 50 to about 150 nm.

8. The energy storage device of claim 1, wherein the LDH nanotubes have a diameter of about 100 nm.

9. The energy storage device of claim 1, wherein the LDH particles comprise sulfidated Ni—Co—Fe particles.

10. The energy storage device of claim 1, wherein the LDH nanotubes or LDH particles comprise aluminum, barium, bismuth, cadmium, calcium, chromium, cobalt, coppern, indium, iron, lead, manganese, mercury, nickel, strontium, tin, zinc, or any combination thereof.

11. The energy storage device of claim 1, wherein the electrolyte comprises a hydroxide and a stabilizer.

12. The energy storage device of claim 1, wherein the hydroxide comprises aluminum hydroxide, barium hydroxide, benzyltrimethylammonium hydroxide, beryllium hydroxide, cadmium hydroxide, cesium hydroxide, calcium hydroxide, cerium(III) hydroxide, chromium acetate hydroxide, chromium(III) hydroxide, cobalt(II) hydroxide, cobalt(III) hydroxide, copper(I) hydroxide, copper(II) hydroxide, curium hydroxide, gallium(III) hydroxide, germanium(II) hydroxide, gold(III) hydroxide, indium(III) hydroxide, iron(II) hydroxide, iron(III) oxide-hydroxide, lanthanum hydroxide, lead(II) hydroxide, lead(IV) hydroxide, lithium hydroxide, magnesium hydroxide, manganese(II) hydroxide, mercury(II) hydroxide, metal hydroxide, nickel(II) hydroxide, potassium hydroxide, rubidium hydroxide, sodium hydroxide, strontium hydroxide, tetrabutylammonium hydroxide, tetramethylammonium hydroxide, thallium hydroxide, thallium(I) hydroxide, thallium(III) hydroxide, tin(II) hydroxide, uranyl hydroxide, zinc hydroxide, zirconium(IV) hydroxide, or any combination thereof.

13. The energy storage device of claim 1, wherein the stabilizer comprises zinc oxide, zinc hydroxide, sodium zincate, potassium zincate, bismuth oxide, cadmium oxide, indium sulfate, lead oxide, a metallic zinc powder, or any combination thereof. In some embodiments, the hydrogen evolution inhibitor comprises bismuth oxide, cadmium oxide, a conductive ceramic, lead oxide, a metallic zinc powder antimony sulfate, gallium hydroxide, indium sulfate, lithium hydroxide, or any combination thereof.

14. The energy storage device of claim 1, wherein the electrolyte has a concentration by mass, by volume, or both of the hydroxide of about 22% to about 91%.

15. The energy storage device of claim 1, wherein the electrolyte has a concentration by volume of the hydroxide of about 220 g/L to about 900 g/L.

16. The energy storage device of claim 1, wherein the electrolyte has a concentration by mass, by volume, or both of the stabilizer of about 1% to about 5%.

17. The energy storage device of claim 1, wherein the electrolyte further comprises a conductivity enhancer comprising a conductive ceramic.

18. The energy storage device of claim 1, wherein the conductive ceramic comprises lead zirconate titanate (PZT), barium titanate(BT), strontium titanate (ST), calcium titanate (CT), magnesium titanate (MT), calcium magnesium titanate (CMT), zinc titanate (ZT), lanthanum titanate (LT), and neodymium titanate (NT), barium zirconate (BZ), calcium zirconate (CZ), lead magnesium niobate (PMN), lead zinc niobate (PZN), lithium niobate (LN), barium stannate (BS), calcium stannate (CS), magnesium aluminum silicate, magnesium silicate, barium tantalate, titanium dioxide, niobium oxide, zirconia, quartz, silica, sapphire, beryllium oxide, zirconium tin titanate, indium tin oxide (ITO), lanthanum-doped strontium titanate (SLT), yttrium-doped strontium titanate (SYT), yttria-stabilized zirconia (YSZ), gadolinium-doped ceria (GDC), lanthanum strontium gallate magnesite (LSGM), or any combination thereof.

19. The energy storage device of claim 1, wherein the electrolyte further comprises:
(a) an additive comprising calcium hydroxide, calcium titanate, calcium zincate, potassium fluoride, sodium phosphate tribasic, potassium phosphate, sodium fluoride, potassium borate, potassium carbonate, or any combination thereof,
(b) a hydrogen evolution inhibitor comprising bismuth oxide, cadmium oxide, a conductive ceramic, lead oxide, a metallic zinc powder antimony sulfate, gallium hydroxide, indium sulfate, lithium hydroxide, or any combination thereof, or
(c) both.

20. The energy storage device of claim 1, wherein a mass ratio between the electroactive materials in the anode and the cathode is about 1:1 to about 7:1.

21. The energy storage device of claim 1, wherein the electrolyte has a concentration of the KOH of about 1 M to about 20 M.

22. The energy storage device of claim 1, further comprising a separator between the anode and the cathode.

23. The energy storage device of claim 1, having a rate capability of at least about 300 mAh/g at 12 A/g.

24. The energy storage device of claim 1, having a rate capability of at least about 100 mAh/g at 300 A/g.

25. The energy storage device of claim 1, having a specific energy of at least about 550 Wh/kg.

26. The energy storage device of claim 1, having a specific power of at least about 400 kW/kg.

27. The energy storage device of claim 1, having a capacity retention of at least about 95% after about 16,000 cycles at 100% depth of discharge.

28. The energy storage device of claim 1, having a time constant of less than about 0.5 seconds.

29. The energy storage device of claim 1, configured for use in an electric vehicle, an energy grid, a home battery, or any combination thereof.

30. An energy storage device comprising:
(a) an anode comprising bimetallic ZnₓM₁₋ₓCO₃ nanoparticles on a graphene scaffold, wherein M is manganese, and wherein x is less than 1;
(b) a cathode comprising sulfidated Ni—Co—Fe layered double hydroxide nanotube; and
(c) an electrolyte.

31. A method of forming an electrode, the method comprising:
(a) forming a first solution comprising graphene oxide and a solvent;
(b) adding zinc nitrate hexahydrate and manganese nitrate tetrahydrate to the first solution;
(c) adding a reducing agent to the first solution to form a second solution;
(d) heating the second solution;
(e) cooling the second solution;
(f) washing the second solution; and
(g) freeze drying the second solution.

32. The method of claim 31, wherein step (a) comprises ultrasonicating the graphene oxide in the solvent.

33. The method of claim 31 or 32, wherein a concentration of the graphene oxide in the first solution is about 0.5 g/L to about 10 g/L.

34. The method of claim 31, 32, or 33, wherein the ultrasonification is performed for about 1 minute to about 120 minutes.

35. The method of any one of claims 31-34, wherein the ultrasonification is performed at room temperature.

36. The method of any one of claims 31-35, wherein the zinc nitrate hexahydrate has a concentration of about 1 mM to about 1,000 mM.

37. The method of any one of claims 31-36, wherein the manganese nitrate tetrahydrate has a concentration of about 0.3 mM to about 300 mM.

38. The method of any one of claims 31-37, wherein step (c) occurs for a period of time of at least about 0.1 hour to about 10 hours.

39. The method of any one of claims 31-38, wherein a molar ratio of Zn²⁺ to Mn²⁺ is about 1:1 to about 7:1.

40. The method of any one of claims 31-39, wherein the reducing/doping agent comprises urea, hydrazine hydrate, sodium borohydride, ascorbic acid, hydroquinone, sodium cholate, sodium citrate, hydroiodic acid, bovine serum albumin, dopamine, glucose, fructose, sucrose, melatonin, starch, oxalic acid, tannic acid, gallic acid, caffeic acid, or any combination thereof.

41. The method of any one of claims 31-40, wherein step (d) is performed at a temperature of about 90° C. to about 200° C.

42. The method of any one of claims 31-41, wherein step (d) is performed for a period of time of about 1 hour to about 24 hours.

43. The method of any one of claims 31-42, further comprising stirring the first solution before step (c), after step (c), or both.

44. The method of claim 43, wherein stirring the first solution is performed for a period of time of about 1 minute to about 100 minutes.

45. The method of any one of claims 31-44, further comprising:
(a) adding a conductive additive, a binder, and a solvent to the second solution to form a slurry;
(b) coating a current collector with the slurry; and
(c) drying the slurry on the current collector.

46. The method of claim 45, wherein the conductive additive comprises carbon black, graphene, carbon nanotubes, graphite, carbon nanofibers, or any combination thereof.

47. The method of claim 45 or 46, wherein the binder comprises polytetrafluoroethylene, styrene butadiene rubber, carboxymethyl cellulose, polyvinylidene fluoride, or any combination thereof.

48. The method of claim 45, 46, or 47, wherein the solvent comprises ethanol, polyvinylidene fluoride, or any combination thereof.

49. The method of any one of claims 45-48, wherein the slurry is dried on the current collector a temperature of about 30° C. to about 100° C.

50. The method of any one of claims 45-49, wherein the slurry is dried on the current collector for a period of time of about 1 hour to about 24 hours.

51. A method of forming an electrode, the method comprising:
(a) synthesizing Ni—Co—Fe layer double hydroxide nanoplatelets;
(b) heating the Ni—Co—Fe layer double hydroxide nanoplatelets; and
(c) drying the Ni—Co—Fe layer double hydroxide nanoplatelets.

52. The method of claim 51, wherein step (a) comprises:
(a) immersing a metal foam in an acid;
(b) washing the metal foam;
(c) electrodepositing the metal foam in a electrosynthesis solution; and
(d) washing the Ni—Co—Fe layer double hydroxide nanoplatelets on the metal foam.

53. The method of claim 51 or 52, wherein the electrodeposition is performed by a three-electrode (3E) cell comprising:
(a) the metal foam as a working electrode;
(b) a reference electrode; and
(c) a counter electrode.

54. The method of claim 51, 52 or 53, wherein the reference electrode comprises Ag/AgCl, Hg/HgO, saturated calomel, or any combination thereof.

55. The method of any one of claims 51-54, wherein the counter electrode comprises platinum, gold, carbon, graphite, or any combination thereof.

56. The method of any one of claims 51-55, wherein the acid comprises HCl, HNO₃, or both.

57. The method of any one of claims 51-56, wherein the washing is performed for a period of time of about 1 minute to about 10 minutes.

58. The method of any one of claims 51-57, wherein the electrodeposition is performed by applying two or more consecutive potential cycles.

59. The method of any one of claims 51-58, wherein the electrodeposition is performed by applying about 10 to about 15 consecutive potential cycles.

60. The method of any one of claims 51-59, wherein the electrodeposition is performed for a period of time of less than about 5 minutes.

61. The method of any one of claims 51-60, wherein the electrodeposition is performed from about −0.7 V to about −1.2 V.

62. The method of any one of claims 51-61, wherein the electrodeposition is performed at a scan rate of about 1 mV/s to about 1,000 mV/s.

63. The method of any one of claims 51-62, wherein the electrosynthesis solution comprises Co(NO₃)2·6H₂O, Ni(NO₃)2·6H₂O, Fe(NO₃)3·9H₂O, and KNO₃.

64. The method of any one of claims 51-63, further comprising drying the Ni—Co—Fe layer double hydroxide nanoplatelets on the metal foam.

65. The method of claim 64, wherein drying the Ni—Co—Fe layer double hydroxide nanoplatelets on the metal foam is performed at a temperature of about 30° C. to about 100° C.

66. The method of claim 64 or 65, wherein drying the Ni—Co—Fe layer double hydroxide nanoplatelets on the metal foam is performed for a period of time of about 1 hour to about 24 hours.

67. The method of claim 64, 65, or 66, wherein the Ni—Co—Fe layer double hydroxide nanoplatelets is heated at a temperature of about 90° C. to about 200° C.

68. The method of any one of claims 64-67, wherein the Ni—Co—Fe layer double hydroxide nanoplatelets is heated for a time period of about 1 hour to about 24 hours.

69. The method of any one of claims 64-68, wherein the Ni—Co—Fe layer double hydroxide nanoplatelets are dried at room temperature.

70. The method of any one of claims 64-69, further comprising washing the Ni—Co—Fe layer double hydroxide nanoplatelets before heating the Ni—Co—Fe layer double hydroxide nanoplatelets.

71. The method of any one of claims 51-70, wherein the method is performed in less than about 5 minutes.

72. The method of any one of claims 51-71, wherein the metal foam comprises a nickel foam.

73. The method of any one of claims 51-72, further comprising sulfidating the Ni—Co—Fe layer double hydroxide nanoplatelets.

74. The method of claim 73, wherein sulfidating the Ni—Co—Fe layer double hydroxide nanoplatelets comprises heating the Ni—Co—Fe layer double hydroxide nanoplatelets in the presence of a sulfidizing agent.

75. The method of claim 74, wherein the sulfidizing agent comprises Na2S.

76. The method of claim 74, wherein the heating is performed at a temperature of about 100° C. to about 180° C.

77. The method of claim 74, wherein the heating is performed for a period of time of about 4 hours to about 12 hours.

78. A method of applying regenerative voltage pulse to a zinc-based energy storage device to maintain or increase the initial capacity, the method comprising: after a sequence of at least 10 galvanostatic charge-discharge (GCD) cycles:
(a) applying a first voltage pulse at a first voltage for a first period of time;
(b) applying a second voltage pulse at a second voltage for a second period of time;
(c) repeating (a) and (b) at least every 10 galvanostatic charge-discharge (GCD) cycles; and
(d) maintaining 100% of the initial device capacity after about 100 galvanostatic charge-discharge (GCD) cycles.

79. The method of claim 78, wherein the first voltage is greater than the second voltage.

80. The method of claim 78, wherein the first voltage is about 1.5 V to about 2.5 V.

81. The method of claim 78, wherein the first voltage is 2.05 V.

82. The method of claim 78 or 79, wherein the second voltage is about 1 V to about 1.5 V.

83. The method of claim 78, wherein the second voltage is 1.3 V.

84. The method of claim 78, 79, or 82, wherein the first period of time, the second period of time, or both is about 15 seconds to about 30 seconds.

85. The method of any one of claims 78-84, wherein the sequence of GCD cycles comprises about 8 GCD cycles to about 14 GCD cycles.

86. The method of claim 78, wherein (a) and (b) result in structural reorganization of an active materials during cycling of the energy storage device.

87. The method of claim 78, wherein (a) and (b) result in the expansion of pores within an active material during cycling of the energy storage device.

88. The method of claim 78, wherein (a) and (b) result in the expansion of pores within an active material during cycling of the energy storage device and increased penetration of electrolyte ions the pores.

89. The method of claim 78, wherein (a) and (b) result in kinetic activation of the electrode.

90. The method of claim 78, wherein the zinc-based energy storage device comprises:
(a) an anode comprising bimetallic ZnₓM₁₋ₓCO₃ nanoparticles on a graphene scaffold, wherein M is iron, cobalt, aluminum, manganese, or any combination thereof, and wherein x is less than 1;
(b) a cathode comprising sulfidated Ni—Co—Fe layered double hydroxide nanotubes;
(c) an electrolyte; or
(d) combinations thereof.
